(19) United States
(12) Patent Application Publication
(10) Pub. No.: US 2024/0165731 A1
(43) Pub. Date: May 23, 2024

(54) WELDING DATA PROCESSING DEVICE AND WELDING DATA PROCESSING METHOD

(71) Applicant: JGC CORPORATION, Kanagawa (JP)

(72) Inventors: Bin ZHOU, Kanagawa (JP); Nobutaka TANAKA, Kanagawa (JP); Yuhei SHIRAKI, Kanagawa (JP)

(73) Assignee: JGC CORPORATION, Kanagawa (JP)

(21) Appl. No.: 18/281,561

(22) PCT Filed: Jun. 7, 2021
(86) PCT No.: PCT/JP2021/021508

§ 371 Date: Sep. 11, 2023

(51) Int. Cl. B23K 9/095

(52) U.S. Cl. CPC B23K 9/0953

(57) ABSTRACT

Provided is a welding data processing device that enables effective use of findings derived from a welding execution record and a result of judgment of whether there is a weld defect. A welding data processing device includes a welding process registration module which registers, for each weld point, a welding condition and a welding execution record in a welding process performed under the welding condition in a welding process database, an inspection process registration module which registers, for each weld point, defect judgment data indicating a result of judgment of whether a weld defect exists at the weld point based on image data of the weld point acquired in a radiographic test process in an inspection process database, and an information processing module which performs predetermined processing based on information registered in the welding process database and the inspection process database.

### TECHNICAL FIELD

The present invention relates to a welding data processing device and a welding data processing method.

### BACKGROUND ART

Hitherto, a welding state during a welding operation has been monitored and recorded as a welding execution record in a welding machine for the purpose of quality control and traceability of a welding process. For example, in Patent Literature 1, there is disclosed a welding machine that detects a welding state, such as a current, a voltage, and a weld time, by a welding state detecting device and records the detected welding state as welding information (a welding execution record) in a recording medium during a welding operation.

### CITATION LIST

### Patent Literature

[PTL 1] JP 2000-042782 A

### SUMMARY OF INVENTION

### Technical Problem

In a construction site for a plant facility, a ship, or the like, a plurality of weld points are provided. After a welding process using a welding machine is performed, a radiographic test process is performed. In the radiographic test process, it is judged whether there is a weld defect at each weld point based on image data obtained by applying radiation to the weld point.

However, the welding execution record acquired as the welding information in the welding machine as disclosed in Patent Literature 1 is not associated with defect judgment data showing the result of judgment of whether there is a weld defect in the radiographic test process, and the welding execution record and the defect judgment data are not managed in an integrated manner. Therefore, findings derived by performing various types of processing, such as analysis, prediction, and machine learning, through use of both the welding execution record and the defect judgment data for each weld point have not been used effectively.

The present invention has been made in view of the above-mentioned problem, and it is an object of the present invention to provide a welding data processing device and a welding data processing method that enable effective use of findings derived from a welding execution record and a result of judgment of whether there is a weld defect.

### Solution to Problem

In order to achieve the above-mentioned object, according to one aspect of the present invention, there is provided a welding data processing device including: a welding process registration module configured to register, for each weld point, a welding condition and a welding execution record in a welding process performed under the welding condition in a welding process database; an inspection process registration module configured to register, for the each weld point, defect judgment data in an inspection process database, the defect judgment data indicating a result of judgment of whether a weld defect exists at the each weld point based on image data of the each weld point acquired in a radiographic test process; and an information processing module configured to perform predetermined processing based on information registered in the welding process database and the inspection process database.

### Advantageous Effects of Invention

According to the welding data processing device of the one aspect of the present invention, the information processing module performs the predetermined processing based on the welding execution record registered in the welding process database and the defect judgment data registered in the inspection process database. Therefore, findings derived from the welding execution record and the defect judgment data can be used effectively.

Problems, configurations, and effects other than those described above become apparent in the “Description of Embodiments” section described later.

### BRIEF DESCRIPTION OF DRAWINGS

FIG. 1 is an overall view of an example of a welding integrated management system (1).

FIG. 2 is a spool diagram for showing an example of weld points (11) provided in a welding site (10).

FIG. 3 is a configuration diagram of an example of a welding machine (6).

FIG. 4 is a configuration diagram of an example of an inspection machine (7).

FIG. 5 is a block diagram of an example of a welding data processing device (2).

FIG. 6 is a data structure diagram of an example of a welding process database (211).

FIG. 7 is a data structure diagram of an example of an inspection process database (212).

FIG. 8 is a hardware configuration diagram of an example of a computer (900) configuring each device of the welding integrated management system (1).

FIG. 9 is a flowchart of an example of registration processing, qualification judgment processing, and deviation judgment processing in a welding process.

FIG. 10 is a flowchart of the example of the registration processing, the qualification judgment processing, and the deviation judgment processing in the welding process (continuation of FIG. 9).

FIG. 11 is a flowchart of an example of registration processing and qualification judgment processing in an imaging process.

FIG. 12 is a flowchart of an example of registration processing and qualification judgment processing in an image judgment process.

FIG. 13 is a flowchart of an example of defect analysis processing.

FIG. 14 is a diagram of an example of an analysis condition input screen (42).

FIG. 15 is a diagram of an example of an analysis result display screen (43) in the defect analysis processing.

FIG. 16 is a flowchart of an example of qualification ineligibility analysis processing.

FIG. 17 is a diagram of an example of an analysis result display screen (44) in the qualification ineligibility analysis processing.

FIG. 18 is a flowchart of an example of deviation analysis processing.

FIG. 19 is a diagram of an example of an analysis result display screen (45) in the deviation analysis processing.

FIG. 20 is a flowchart of an example of welding assist processing.

FIG. 21 is a flowchart of an example of defect prediction processing.

FIG. 22 is a schematic diagram of an example of machine learning processing and defect inference processing.

FIG. 23 is a flowchart of an example of the defect inference processing.

### DESCRIPTION OF EMBODIMENTS

Embodiments for carrying out the present invention are described below with reference to the drawings. In the following description, a range required for the description for achieving the object of the present invention is schematically shown, and a range required for the description of a portion corresponding to the present invention is mainly described. A portion of which the description is omitted is based on a known technology.

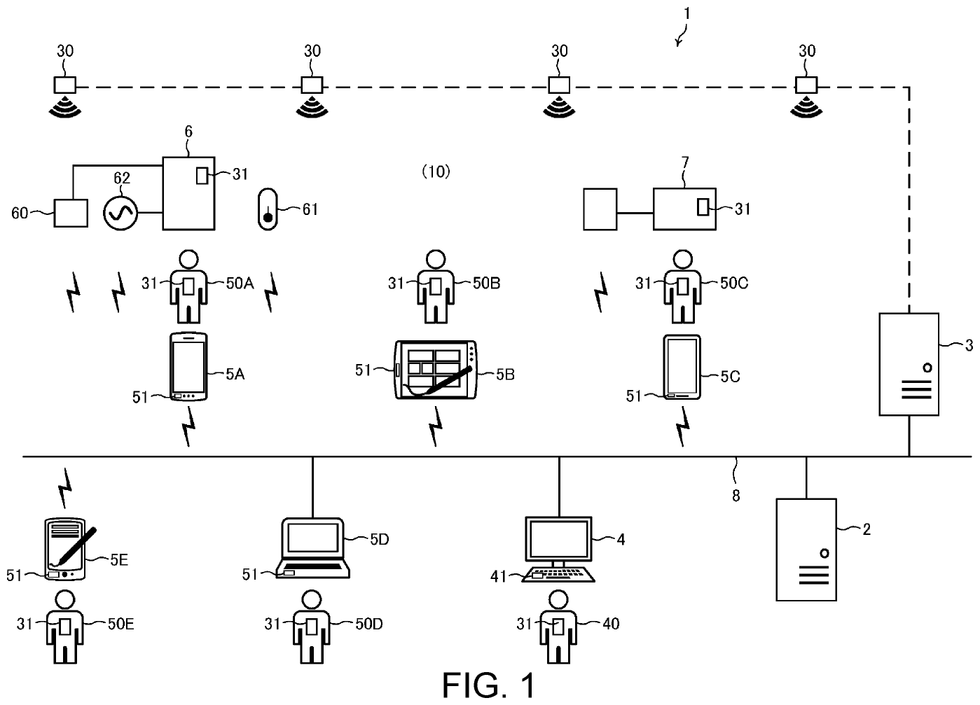

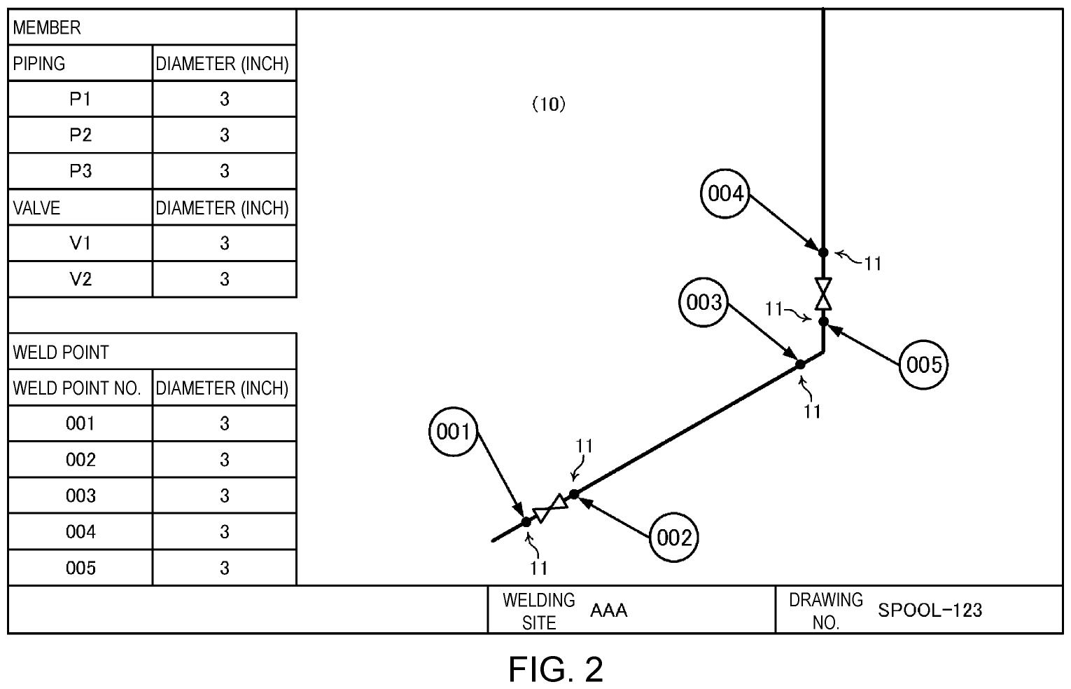

FIG. 1 is an overall view of an example of a welding integrated management system 1. FIG. 2 is a spool diagram for showing an example of weld points 11 provided in a welding site 10. The welding integrated management system 1 is a system for managing a welding process and a radiographic test process performed at each of the weld points 11 provided at various locations in the welding site 10 in an integrated manner.

The welding integrated management system 1 includes, as main components, a welding data processing device 2, a construction progress management device 3, a manager's terminal 4, a welder's terminal 5A, a welding manager's terminal 5B, an imaging worker's terminal 5C, a judge's terminal 5D, and an inspection manager's terminal 5E. In addition, the welding integrated management system 1 includes a welding machine 6, a welding machine monitoring device 60, a temperature measurement device 61, and a distribution board 62 as devices used in the welding process and also includes an inspection device 7 as a device used in the radiographic test process. Although FIG. 1 shows only one of each device of the welding integrated management system 1 for the sake of simplicity of the drawing, the number and arrangement of each device are not limited to those of FIG. 1.

The above-mentioned devices of the welding integrated management system 1 are connected to a wired or wireless network 8 and configured to be able to transmit and receive various types of data mutually. The form of the network 8 is not limited to the example of FIG. 1, and may be changed appropriately. For example, a plurality of sub-networks independent of each other, such as a sub-network formed by the welding data processing devices 2 and a sub-network formed by the construction progress management devices 3, may be connected to an integrated network formed by the manager's terminals 4, and thus the network 8 is formed by those devices as a whole.

Examples of the welding site 10 include plant facilities such as a natural gas plant, a petroleum processing plant, a chemical processing plant, a power plant, and a steel plant, and a ship construction site at which a tanker, a cargo ship, a passenger ship, or the like is constructed. In the welding site 10, a welder 50A, a welding manager 50B, an imaging worker 50C, a judge 50D, and an inspection manager 50E (hereinafter referred to as “workers 50A to 50E”), who belong to subcontractors undertaking a welding process and a radiographic test process, perform various works associated with the welding process and the radiographic test process under process management by a site manager 40 of a prime contractor. Therefore, the welding integrated management system 1 is used by, for example, the prime contractor to manage the welding process and the radiographic test process performed by the subcontractors.

The welding site 10 is divided into a plurality of welding areas and managed by welding area. For example, the welding site 10 is managed by dividing the above-mentioned building into a plurality of welding areas in accordance with a division criterion such as hierarchy, section, and purpose of use. The welding site 10 is provided not only when the above-mentioned building is newly constructed but also when the building is renovated. The welding site 10 is not limited to the above-mentioned examples of building, and may be any building as long as the weld points 11 are provided at various locations therein.

The weld point 11 is represented in a spool diagram drawn as a part of design drawings of a plant, a ship, or the like that is the welding site 10, as illustrated in FIG. 2. The weld point 11 is a point in the welding site 10, at which pipings allowing any fluid to flow therein are welded to each other, a piping and a piping joint member (for example, a flange, an elbow, or a tee) are welded to each other, or piping joint members are welded to each other. The weld point 11 is not limited to the above-mentioned examples, as long as the weld point 11 is a point at which members are welded to each other.

The welding process is a work process performed by the welder 50A using the welding machine 6 under a welding condition determined for each weld point 11. In this embodiment, the welding process is described focusing on the case of using arc welding. However, any welding method, for example, gas welding, laser welding, electron beam welding, and resistance pressure welding may be used.

As the welding condition in the welding process, for example, diameter, thickness, material (base material), joint shape, welding material, preheating, post-weld heat treatment, shielding gas, electrical characteristics (welding current, welding voltage, and the like), and welding method (welding speed, welding direction, welding angle, arc time) for the weld point 11 are determined. The welding condition is determined for each weld point 11 by, for example, operation instructions for the welding process, and information as a part of the welding condition is represented in a spool diagram (see FIG. 2). In addition, welding machine operation data in which the operating state of the welding machine 6 is recorded and preheating data in which the preheating state of the weld point 11 is recorded, for example, are acquired as a welding execution record in the welding process that has been performed under the welding condition.

The radiographic test process includes an imaging process in which the imaging worker 50C applies radiation (X-ray, y-ray, or the like) to the weld point 11 for which the welding process has been performed through use of the inspection machine 7 to acquire the intensity of radiation transmitted through the weld point 11 as image data, and an image judgment process in which the judge 50D judges whether there is a weld defect at that weld point 11 based on the image data through use of the judge's terminal 5D. Weld defects are classified into defect types such as a blowhole, a pit, a crack, an undercut, and an overlap. When the size, the depth, or the shape of a weld defect exceeds an allowable range, the weld point 11 is judged to be “defective” (fail), and when the size, the depth, or the shape of a weld defect does not exceed the allowable range, the weld point 11 is determined to be “non-defective” (pass). In the image judgment process, defect judgment data which indicates the result of the judgment of whether there is a weld defect based on the image data of the weld point 11 is acquired.

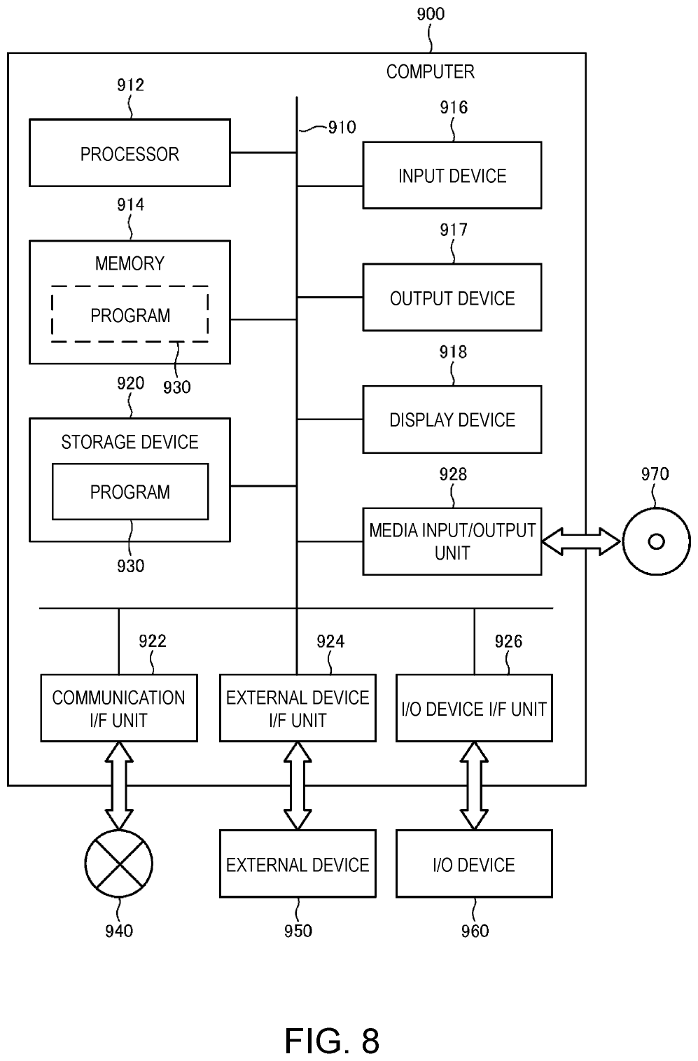

The welding data processing device 2 is configured by, for example, a general-purpose or dedicated computer (see FIG. 8 described later). The welding data processing device 2 manages various types of data acquired in the welding process and the radiographic test process. The details of the welding data processing device 2 are described later.

The construction progress management device 3 is configured by, for example, a general-purpose or dedicated computer (see FIG. 8 described later). The construction progress management device 3 manages design data that includes, for example, design drawings, spool diagrams, and operation instructions of a building as the welding site 10 and progress management data that includes work schedules and the state of progress of an entire construction process including the welding process and the radiographic test process. The design data and the progress management data are displayed on display screens of the manager's terminal 4 and worker's terminals 5A to 5E. Further, the site manager 40 and the workers 50A to 50E are notified based on the progress management data via the manager's terminal 4 and the worker's terminals 5A to 5E, respectively.

The construction progress management device 3 is connected to beacon receiving devices 30 installed at various locations in the welding site 10. The beacon receiving device 30 receives a beacon signal transmitted from a beacon card 31, to thereby acquire card information included in the beacon signal and acquire the location of the beacon card 31 that is a transmission source of that beacon signal.

The beacon card 31 is held by each of the workers 50A to 50E. The beacon receiving device 30 regularly acquires the card information (for example, identification information (ID) for identifying the workers 50A to 50E) and the current location of the beacon card 31 held by each of the workers 50A to 50E, and thus the construction progress management device 3 acquires location history data of each of the workers 50A to 50E. Further, the beacon card 31 is attached to each of the welding machine 6 and the inspection machine 7. The beacon receiving device 30 regularly acquires the card information (for example, identification information (ID) for identifying the welding machine 6 and the inspection machine 7) and the current location of the beacon card 31 attached to each of the welding machine 6 and the inspection machine 7, and thus the construction progress management device 3 acquires location history data of each of the welding machine 6 and the inspection machine 7.

The manager's terminal 4 is configured by, for example, a general-purpose or dedicated computer (see FIG. 8 described later) and is used by the site manager 40. The manager's terminal 4 includes a card reader 41 that reads the card information of the beacon card 31. Further, the manager's terminal 4 receives various input operations via its input screen and displays various types of information via a display screen of an application, a browser, or the like.

The welder's terminal 5A, the welding manager's terminal 5B, the imaging worker's terminal 5C, the judge's terminal 5D, and the inspection manager's terminal 5E (hereinafter referred to as “worker's terminal 5A to 5E”) are each configured by, for example, a general-purpose or dedicated computer (see FIG. 8 described later) and are used by the workers 50A to 50E, respectively. The worker's terminals 5A to 5E each include a card reader 51 that reads the card information of the beacon card 31. Further, each of the worker's terminal 5A to 5E receives various input operations via its input screen and displays various types of information via a display screen of an application, a browser, or the like, as with the manager's terminal 4.

The welder's terminal 5A, the welding manager's terminal 5B, the imaging worker's terminal 5C, and the inspection manager's terminal 5E are used when the welder 50A, the welding manager 50B, the imaging worker 50C, and the inspection manager 50E move to each weld point 11 and perform work there. Therefore, those terminals are preferably configured by portable computers. The judge's terminal 5D receives image data acquired in the imaging process in the radiographic test process, for example, via the network 8 (including the Internet) and displays an image, thereby being used when the judge 50D performs work at a location different from the weld point 11. Therefore, the judge's terminal 5D may be configured by any of a portable computer and a stationary computer.

(Configuration of Welding Machine 6)

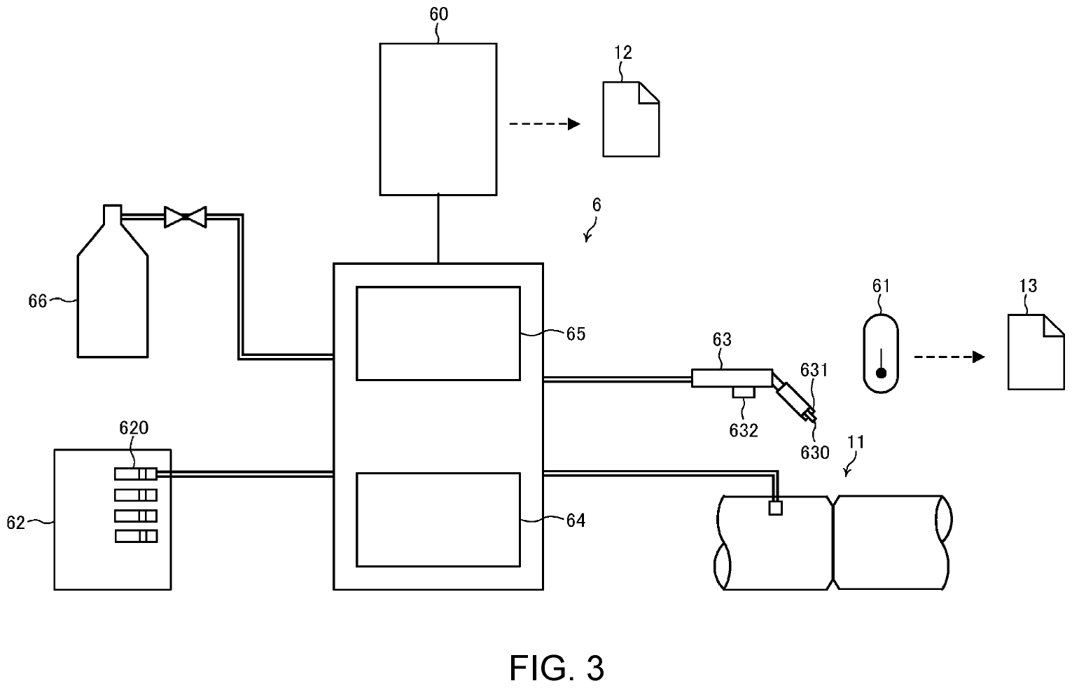

FIG. 3 is a configuration diagram of an example of the welding machine 6. The welding machine 6 includes a welding torch 63 to be grasped by the welder 50A, a power supply circuit 64 that receives electric power supplied from the distribution board 62 and outputs a predetermined welding current to the welding torch 63, and an operation control panel 65 that receives various input operations (for example, a setting operation of setting the electrical characteristics in the welding condition) and controls each part of the welding machine 6. The welding torch 63 includes a discharge electrode 630, a nozzle 631 that supplies shielding gas from a gas tank 66, and an on-off switch 632.

For example, the welder 50A causes the welder's terminal 5A to display a spool diagram and/or operation instructions for the weld point 11 as a work target to confirm the welding condition for the weld point 11, and sets the welding condition for that weld point 11 on the operation control panel 65. Then, when the welder 50A brings the welding torch 63 close to the weld point 11 and turns on the switch 632, an arc is generated between the welding torch 63 to which a predetermined welding voltage is applied by the power supply circuit 64 and the weld point 11, and thus welding of the weld point 11 is executed.

The welding machine monitoring device 60 is connected to the power supply circuit 64 and generates welding machine operation data 12 in which the operating state of the welding machine 6 is recorded in accordance with execution of welding. For example, in the welding machine operation data 12, time-series data of a welding current, a welding voltage, a welding speed, a welding direction, and a welding angle, the average value, the maximum value, and the minimum value for each of those values, and an arc time are recorded as detailed data representing the operating state of the welding machine 6.

The temperature measurement device 61 is configured by, for example, a non-contact thermometer and generates preheating data 13 in which the preheating state of the weld point 11 is recorded before welding is performed. For example, in the preheating data 13, time-series data of a surface temperature of a piping, the average value, the lowest temperature, and the highest temperature of a preheating temperature, and a preheating time are recorded as detailed data representing the preheating state of the weld point 11.

The distribution board 62 includes a switch 620 to which a power line for supplying electric power to the welding machine 6 is connected. When receiving a switch control instruction from the welding data processing device 2, the distribution board 62 switches the switch 620 from an energized state to a cut-off state.

(Configuration of Inspection Machine 7)

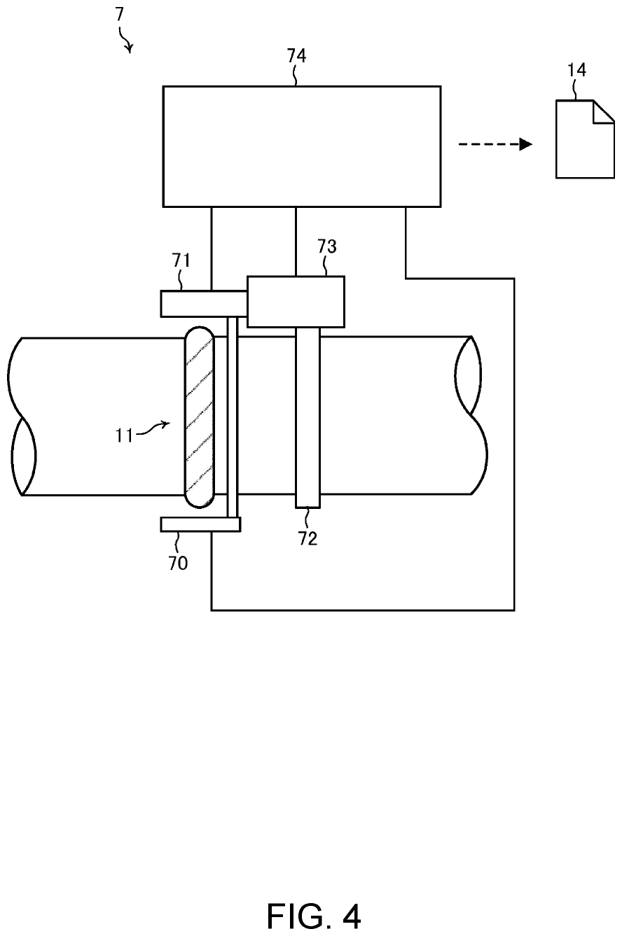

FIG. 4 is a configuration diagram of an example of the inspection machine 7. The inspection machine 7 includes a radiation irradiation unit 70 that applies radiation to the weld point 11, a detector 71 arranged to be opposed to the radiation irradiation unit 70, a guide 72 mounted to the outer circumference of the weld point 11 to be detachable, a driving unit 73 that moves the radiation irradiation unit 70 and the detector 71 along the guide 72 in the circumferential direction, and an operation control panel 74 that receives various input operations and controls each part of the inspection machine 7. The detector 71 is configured by, for example, a flat panel detector (FPD). The above-mentioned configuration of the inspection machine 7 is merely an example. For example, the inspection machine 7 may include the detector 71 configured by a computed radiography (CR).

For example, when the imaging worker 50C mounts the guide 72 to the weld point 11 as a work target and performs an imaging start operation on the operation control panel 74, the operation control panel 74 moves the radiation irradiation unit 70 and the detector 71 along the guide 72 in the circumferential direction by the driving unit 73 and causes the radiation irradiation unit 70 and the detector 71 to operate. Accordingly, the radiation irradiation unit 70 applies radiation to the weld point 11, and the detector 71 detects the intensity distribution of radiation transmitted through the weld point 11, and thus the operation control panel 74 generates image data 14 in which the weld point 11 is recorded over the entire circumference.

(Configuration of Welding Data Processing Device 2)

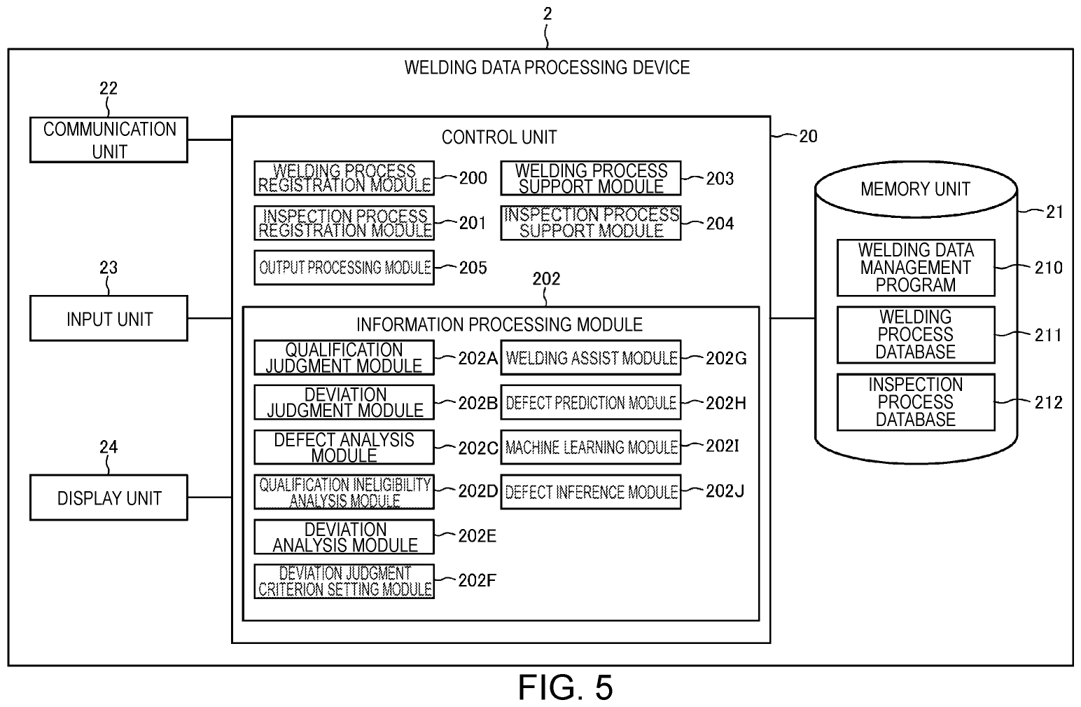

FIG. 5 is a block diagram of an example of the welding data processing device 2. The welding data processing device 2 includes a control unit 20 configured by a processor or the like, a memory unit 21 configured by a hard disk drive (HDD), a solid state drive (SSD), a memory, or the like, a communication unit 22 that is an interface for communication to and from the network 8, an input unit 23 configured by a keyboard and/or a mouse, for example, and a display unit 24 configured by a display or the like. The input unit 23 and the display unit 24 may be omitted.

The memory unit 21 stores therein a welding data processing program 210, a welding process database 211, and an inspection process database 212.

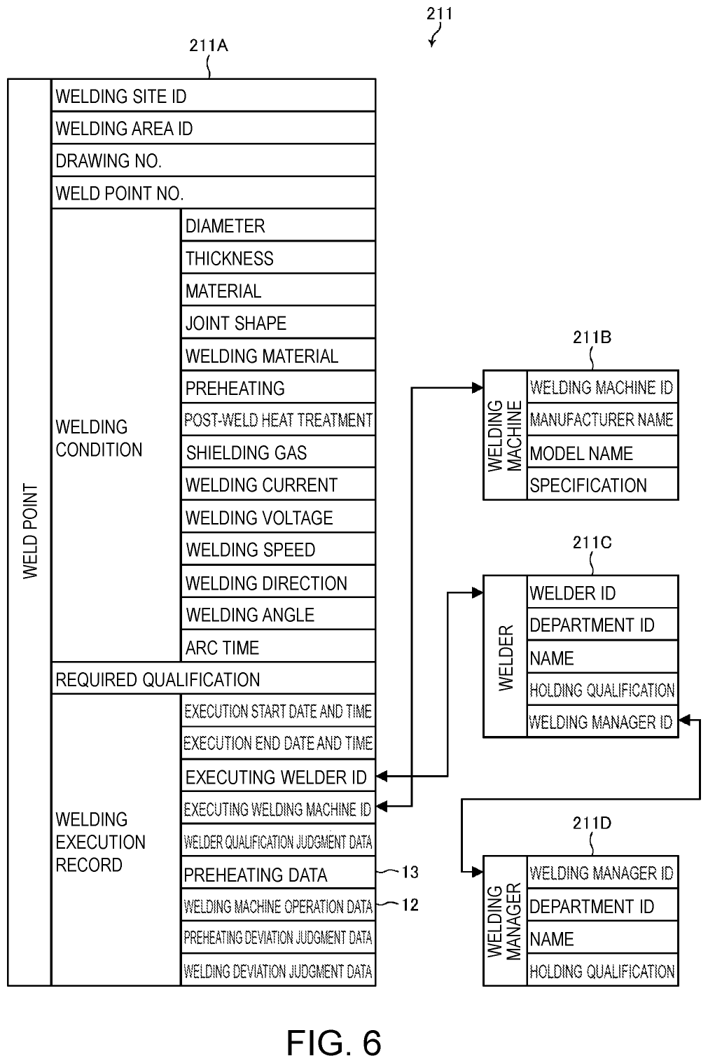

FIG. 6 is a data structure diagram of an example of the welding process database 211. The welding process database 211 includes a weld point table 211A, a welding machine table 211B, a welder table 211C, and a welding manager table 211D.

In the weld point table 211A, welding condition, required qualification, and welding execution record are registered for each weld point 11 identified by a welding site ID, a welding area ID, a drawing number, and a weld point number. The welding condition includes, as its fields, diameter, thickness, material (base material), joint shape, welding material, preheating, post-weld heat treatment, shielding gas, welding current, welding voltage, welding speed, welding direction, welding angle, and arc time. The welding execution record includes, as its fields, execution start date and time, execution end date and time, executing welder ID, executing welding machine ID, welder qualification judgment data, preheating data 13, welding machine operation data 12, preheating deviation judgment data, and welding deviation judgment data.

In the welding machine table 211B, manufacturer name, model name, and specification are registered for each welding machine 6 identified by a welding machine ID. In the welder table 211C, department ID, name, holding qualification, and welding manager ID are registered for each welder 50A identified by a welder ID. In the welding manager table 211D, department ID, name, and holding qualification are registered for each welding manager 50B identified by a welding manager ID.

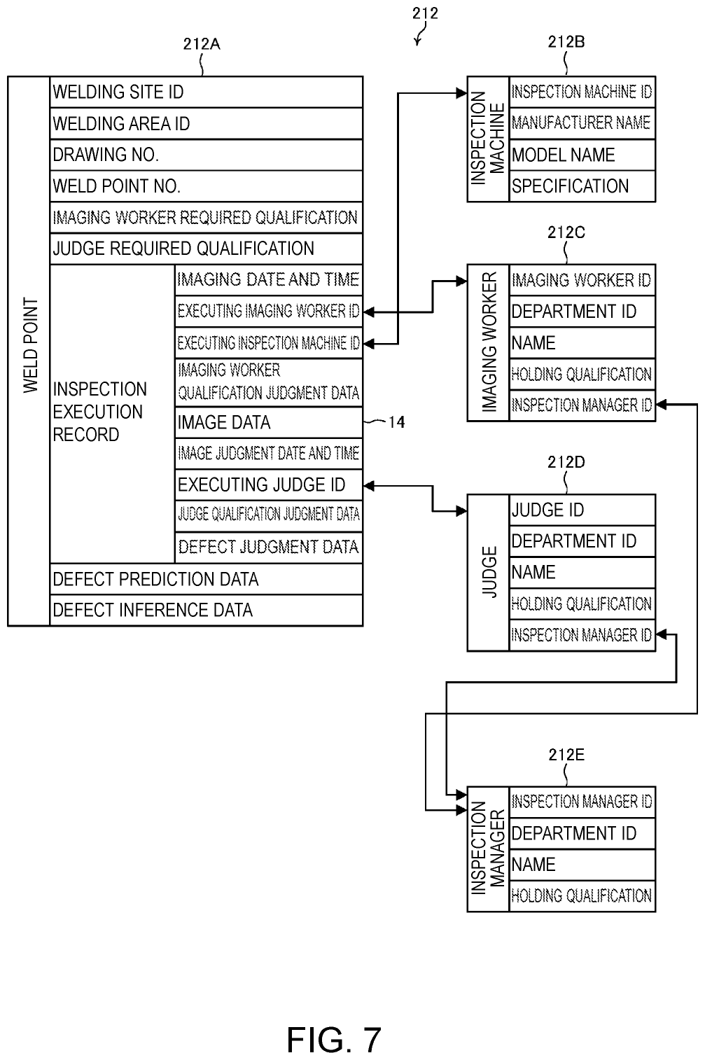

FIG. 7 is a data structure diagram of an example of the inspection process database 212. The inspection process database 212 includes a weld point table 212A, an inspection machine table 212B, an imaging worker table 212C, a judge table 212D, and an inspection manager table 212E.

In the weld point table 212A, imaging worker required qualification, judge required qualification, inspection execution record, defect prediction data, and defect inference data are registered for each weld point 11 identified by a welding site ID, a welding area ID, a drawing number, and a weld point number. The inspection execution record includes, as its fields, imaging date and time, executing imaging worker ID, executing inspection machine ID, imaging worker qualification judgment data, image data 14, image judgment date and time, executing judge ID, judge qualification judgment data, and defect judgment data.

The image data 14 includes one or a plurality of images for one weld point 11. The defect judgment data includes the presence or absence of a weld defect (“defective” or “non-defective”) and further includes a defect detail status indicating a detailed status of the defect in the case of “defective.” The defect detail status includes, as its fields, defect location indicating the location on the image data 14, defect type, size, and depth, for example. In the case in which a plurality of defects are captured in one image data 14, the defect judgment data includes the defect detail status for each defect.

In the inspection machine table 212B, manufacturer name, model name, and specification are registered for each inspection machine 7 identified by an inspection machine ID. In the imaging worker table 212C, department ID, name, holding qualification, and inspection manager ID are registered for each imaging worker 50C identified by an imaging worker ID. In the judge table 212D, department ID, name, holding qualification, and inspection manager ID are registered for each judge 50D identified by a judge ID. In the inspection manager table 212E, department ID, name, and holding qualification are registered for each inspection manager 50E identified by an inspection manager ID.

The data structures of the welding process database 211 and the inspection process database 212 are not limited to the above-mentioned example, and may be changed as appropriate. For example, a part of the above-mentioned fields may be omitted or a field other than the above-mentioned fields may be added. Further, the welding process database 211 and the inspection process database 212 may be stored in an external database management device in place of the memory unit 21 of the welding data processing device 2. In this case, it suffices that the welding data processing device 2 accesses the database management device via the communication unit 22.

The control unit 20 executes the welding data processing program 210 stored in the memory unit 21, to thereby function as a welding process registration module 200, an inspection process registration module 201, an information processing module 202, a welding process support module 203, an inspection process support module 204, and an output processing module 205, as illustrated in FIG. 5.

The welding process registration module 200 registers a welding condition and a welding execution record in a welding process performed under the welding condition in the welding process database 211 for each weld point 11, as its basic function.

The inspection process registration module 201 registers, for each weld point 11, an inspection execution record that includes at least defect judgment data indicating a result of judgment of whether there is a weld defect at the weld point 11 based on image data 14 of the weld point 11 acquired in a radiographic test process, in the inspection process database 212, as its basic function.

The information processing module 202 performs predetermined processing based on information registered in the welding process database 211 and the inspection process database 212. The information processing module 202 includes, as components which perform the predetermined processing, a qualification judgment module 202A, a deviation judgment module 202B, a defect analysis module 202C, a qualification ineligibility analysis module 202D, a deviation analysis module 202E, a deviation judgment criterion setting module 202F, a welding assist module 202G, a defect prediction module 202H, a machine learning module 2021, and a defect inference module 202J. The details of each of the modules 202A to 202J of the information processing module 202 are described later.

The welding process support module 203 performs various types of processing for supporting execution of the welding process in cooperation with the information processing module 202. The inspection process support module 204 performs various types of processing for supporting execution of the inspection process in cooperation with the information processing module 202.

The output processing module 205 generates display data for causing a result of processing by the information processing module 202 to be displayed on, for example, a display screen of an application or a browser running on the manager's terminal 4 and the worker's terminals 5A to 5E, and transmits (outputs) the generated display data to the manager's terminal 4 and the worker's terminals 5A to 5E. The output processing module 205 may generate print data for causing the result of processing by the information processing module 202 to be printed or output by a printer or the like, or may store the processing result in the memory unit 21.

The functions of the respective units included in the control unit 20 may be distributed into a plurality of devices and implemented by those devices, instead of being implemented by a single device (the welding data processing device 2 in this embodiment).

FIG. 8 is a hardware configuration diagram of an example of a computer 900 configuring each device of the welding integrated management system 1.

Each of the welding data processing device 2, the construction progress management device 3, the manager's terminal 4, the worker's terminals 5A to 5E, the operation control panel 65 of the welding machine 6, and the operation control panel 74 of the inspection machine 7 is configured by the general-purpose or dedicated computer 900. The computer 900 includes, as its main components, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a media input/output unit 928, as illustrated in FIG. 8. The above-mentioned components may be omitted as appropriate depending on the application in which the computer 900 is used.

The processor 912 is configured by one or a plurality of arithmetic processing devices (central processing unit (CPU), micro-processing unit (MPU), digital signal processor (DSP), graphics processing unit (GPU), and the like) and operates as a control unit that controls the overall computer 900. The memory 914 stores therein various types of data and a program 930, and is configured by, for example, a volatile memory (such as a DRAM and an SRAM) serving as a main memory, a non-volatile memory (a ROM), a flash memory, and the like.

The input device 916 is configured by, for example, a keyboard, a mouse, a numeric keypad, and/or an electronic pen and serves as an input unit. The output device 917 is configured by, for example, a sound (audio) output device or a vibration device and serves as an output unit. The display device 918 is configured by, for example, a liquid crystal display, an organic EL display, an electronic paper display, or a projector and serves as an output unit. The input device 916 and the display device 918 may be configured integrally, like a touch panel display. The storage device 920 is configured by, for example, an HDD and/or an SSD and serves as a memory unit. The storage device 920 stores therein various types of data required for execution of an operating system and the program 930.

The communication I/F unit 922 is connected to a network 940, such as the Internet and an intranet, (which may be the same as the network 8 of FIG. 1) in a wired or wireless manner and serves as a communication unit that transmits and receives data to and from another computer in accordance with a predetermined communication standard. The external device I/F unit 924 is connected to an external device 950, such as a camera, a printer, a scanner, and a reader/writer, in a wired or wireless manner and serves as a communication unit that transmits and receives data to and from the external device 950 in accordance with a predetermined communication standard. The I/O device I/F unit 926 is connected to an I/O device 960, such as various sensors and an actuator, and serves as a communication unit that transmits and receives various signals, such as a detection signal of a sensor and a control signal to an actuator, and data to and from the I/O device 960. The media input/output unit 928 is configured by a drive device, such as a digital versatile disc (DVD) drive and a compact disc (CD) drive, and writes and reads data to and from a medium (a non-transitory storage medium) 970, such as a DVD and a CD.

In the computer 900 having the above-mentioned configuration, the processor 912 calls the program 930 stored in the storage device 920, executes the program 930 in the memory 914, and controls each part of the computer 900 via the bus 910. The program 930 may be stored in the memory 914 in place of the storage device 920. The program 930 may be recorded in the medium 970 in an installable file format or an executable file format and be provided to the computer 900 via the media input/output unit 928. The program 930 may be provided to the computer 900 by being downloaded through the network 940 via the communication I/F unit 922. Moreover, the computer 900 may be configured in such a manner that various functions implemented by execution of the program 930 by the processor 912 are implemented by hardware, such as a field-programmable gate array (FPGA) and an application specific integrated circuit (ASIC).

The computer 900 is configured by, for example, a stationary computer or a portable computer, and is an electronic device of any form. The computer 900 may be a client computer, a server computer, or a cloud computer.

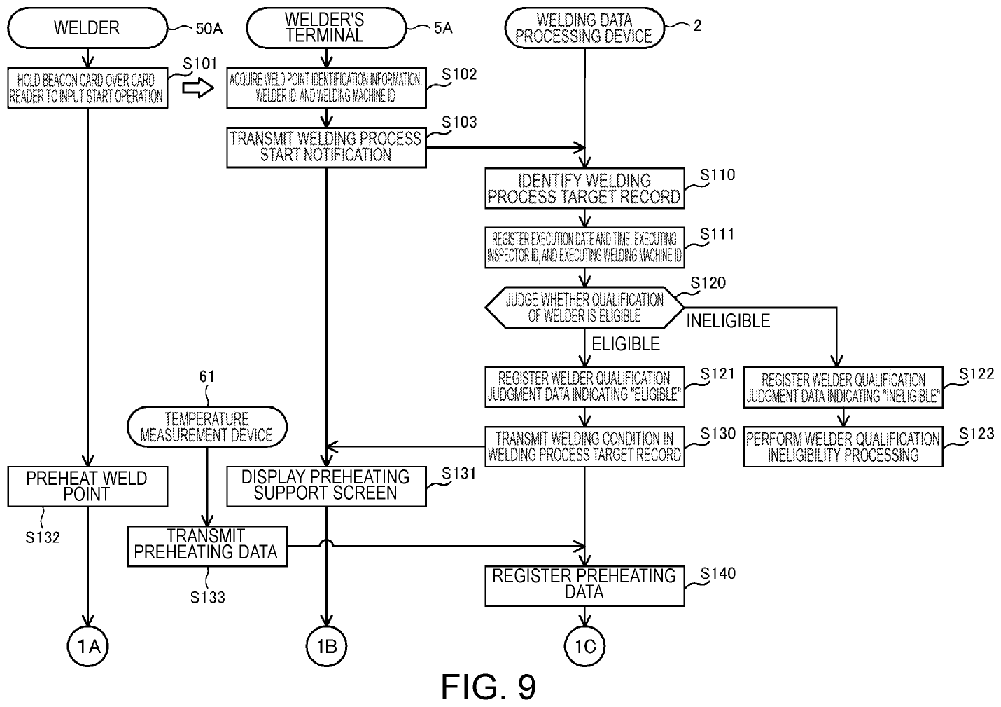

Each module of the welding data processing device 2 (each step of a welding data processing method executed by the welding data processing method) and a series of operations by the welding integrated management system 1 are described below with reference to FIG. 9 to FIG. 25.

(1) Advance Registration in Welding Process Database and Inspection Process Database

The welding process registration module 200 and the inspection process registration module 201 perform, before a welding process and an inspection process are performed, advance registration processing of registering in advance various types of information (except for a welding execution record and an inspection execution record) in the welding process database 211 and the inspection process database 212.

First, the site manager 40 operates the manager's terminal 4 to provide design data managed by the construction progress management device 3 to the welding data processing device 2. The welding process registration module 200 adds a plurality of records corresponding to each of a plurality of weld points 11 provided in the welding site 10 to the weld point table 211A of the welding process database 211, based on the design data provided from the construction progress management device 3.

At this time, the welding process registration module 200 receives, for example, a welding site ID determined based on the name of a building or the like from the manager's terminal 4 operated by the site manager 40, to thereby register the common welding site ID for each weld point 11. The welding process registration module 200 receives welding area IDs respectively assigned to a plurality of welding areas into which the welding site 10 is divided in accordance with a predetermined dividing criterion, to thereby register for each weld point 11 a welding area ID for identifying a welding area including the weld point 11. The welding process registration module 200 takes in a drawing number and a weld point number assigned to each weld point 11 from, for example, a spool diagram of the design data and also takes in a welding condition for each weld point 11 from the spool diagram of the design data and operation instructions. The welding process registration module 200 thus registers the drawing number, the weld point number, and the welding condition for each weld point 11. The welding process registration module 200 then identifies a required qualification required of the welder 50A based on the welding condition for each weld point 11, to thereby register the required qualification required of the welder 50A for each weld point 11.

The welding process registration module 200 also receives information on the welding machine 6 to be used in the welding site 10 from the manager's terminal 4, to thereby assign a welding machine ID for identifying the welding machine 6 to each welding machine 6 and register manufacturer name, model name, and specification for each welding machine 6 in the welding machine table 211B.

Further, the welding process registration module 200 receives information on the welder 50A who is to work in the welding site 10 from the manager's terminal 4, to thereby assign a welder ID for identifying the welder 50A to each welder 50A and register for each welder 50A a department ID for identifying a department (for example, a sub-contractor or a team) to which the welder 50A belongs, a name, a holding qualification, and a welding manager ID for identifying the welding manager 50B managing the welder 50A in the welder table 211C. The welding process registration module 200 receives information on the welding manager 50B managing the welder 50A who is to work in the welding site 10 from the manager's terminal 4, to thereby assign a welding manager ID for identifying the welding manager 50B to each welding manager 50B and register for each welding manager 50B a department ID for identifying a department to which the welding manager 50B belongs, a name, and a holding qualification in the welding manager table 211D.

The inspection process registration module 201 adds a plurality of records corresponding to the respective weld points 11 provided in the welding site 10 to the weld point table 212A of the inspection process database 212, based on the design data provided from the construction progress management device 3, as with the welding process registration module 200. That is, the inspection registration module 201 registers welding site ID, welding area ID, drawing number, and weld point number for each weld point 11. The inspection process registration module 201 then identifies a required qualification required of each of the imaging worker 50C and the judge 50D based on the welding condition for each weld point 11, to thereby register an imaging worker required qualification required of the imaging worker 50C and a judge required qualification required of the judge 50D for each weld point 11.

The inspection process registration module 201 receives information on the inspection machine 7 to be used in the welding site 10 from the manager's terminal 4, to thereby assign an inspection machine ID for identifying the inspection machine 7 to each inspection machine 7 and register manufacturer name, model name, and specification in the inspection machine table 212B for each inspection machine 7.

Further, the inspection process registration module 201 receives information on the imaging worker 50C who is to work in the welding site 10 from the manager's terminal 4, to thereby assign an imaging worker ID for identifying the imaging worker 50C to each imaging worker 50C and register for each imaging worker 50C a department ID for identifying a department (for example, a sub-contractor or a team) to which the imaging worker 50C belongs, a name, a holding qualification, and an inspection manager ID for identifying the inspection manager 50E who manages the imaging worker 50C in the imaging worker table 212C. The inspection process registration module 201 receives information on the judge 50D who is to work in the welding site 10 from the manager's terminal 4, to thereby assign a judge ID for identifying the judge 50D to each judge 50D and register for each judge 50D a department ID for identifying a department to which the judge 50D belongs, a name, a holding qualification, and an inspection manager ID for identifying the inspection manager 50E who manages the judge 50D in the judge table 212D. The inspection process registration module 201 receives information on the inspection manager 50E managing the imaging worker 50C and the judge 50D who are to work in the welding site 10 from the manager's terminal 4, to thereby assign an inspection manager ID for identifying the inspection manager 50E to each inspection manager 50E and register for each inspection manager 50E a department ID for identifying a department to which the inspection manager 50E belongs, a name, and a holding qualification in the inspection manager table 212E.

As described above, information required for execution of a welding process and an inspection process is registered in advance in the welding process database 211 and the inspection process database 212. Note that, a welding execution record and an inspection execution record have not been registered in the stage of advance registration.

(2) Registration of Welding Execution Record in Welding Process

The welding process registration module 200 performs registration processing of registering a welding execution record in the welding process database 211 in association with execution of a welding process. In conjunction with this registration processing, the qualification judgment module 202A performs qualification judgment processing for a holding qualification of the welder 50A, and the deviation judgment module 202B performs deviation judgment processing.

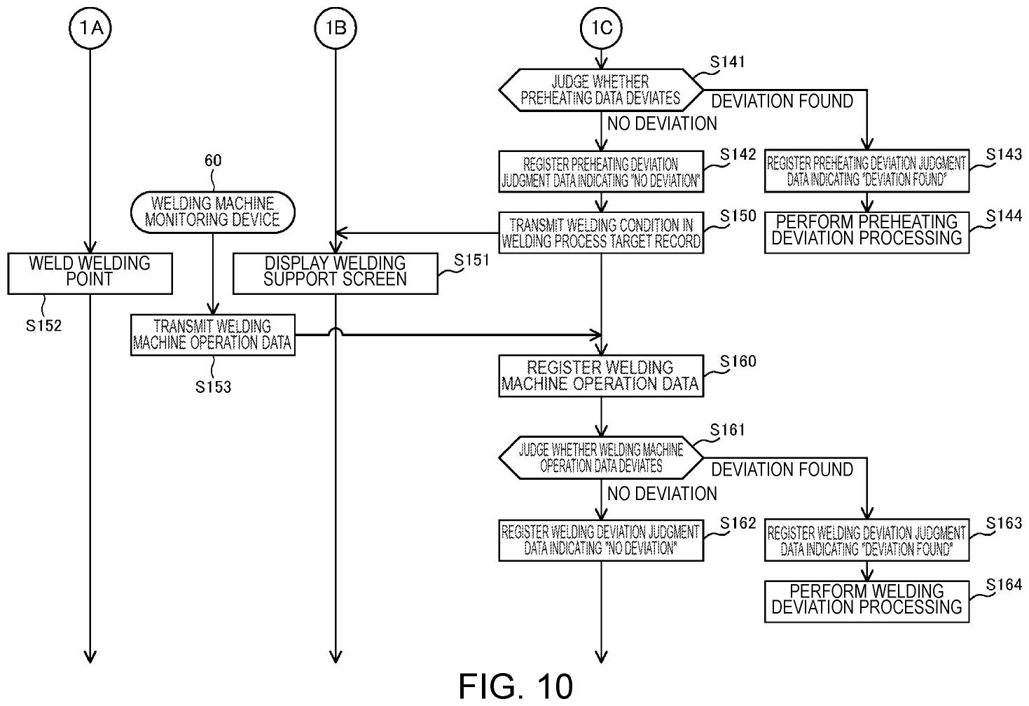

FIG. 9 and FIG. 10 are flowcharts of an example of the registration processing, the qualification judgment processing, and the deviation judgment processing in a welding process. In FIG. 9 and FIG. 10, an operation after the welder 50A who is to perform a welding process moves to a weld point 11 as a work target and installs the welding machine 6 to be used at the weld point 11 as the work target is described.

First, in Step S101, the welder 50A inputs a welding site ID, a welding area ID, a drawing number, and a weld point number to the welder's terminal 5A as weld point identification information for identifying the weld point 11 as the work target, and performs a welding process start operation indicating the start of the welding process. At this time, the welder 50A holds the beacon card 31 thereof over the card reader 51.

Next, in Step S102, the welder's terminal 5A receives the welding process start operation to acquire the weld point identification information. The welder's terminal 5A acquires a welder ID for identifying the welder 50A by reading card information from the beacon card 31 of the welder 50A with the card reader 51. The welder's terminal 5A acquires a welding machine ID for identifying the welding machine 6 by reading card information from the beacon card 31 attached to the welding machine 6 to be used with the card reader 51. The welder's terminal 5A may acquire the welding machine ID from the construction progress management device 3.

Next, in Step S103, the welder's terminal 5A transmits a welding process start notification including the weld point identification information, the welder ID, and the welding machine ID to the welding data processing device 2.

Next, in Step S110, when the welding data processing device 2 receives the welding process start notification from the welder's terminal 5A, the welding process registration module 200 refers to the welding process database 211 to identify a record corresponding to the weld point identification information included in the welding process start notification (hereinafter referred to as “welding process target record”) of the weld point table 211A. In Step S111, the welding process registration module 200 then registers reception date and time of the welding process start notification as execution start date and time in the welding process target record. In addition, the welding process registration module 200 registers the welder ID included in the welding process start notification as an executing welder ID in the welding process target record and also registers the welding machine ID included in the welding process start notification as an executing welding machine ID in the welding process target record.

Next, in Step S120, the qualification judgment module 202A refers to the welding process database 211 and judges eligibility of qualification, that is, whether the welder 50A who is to perform the welding process at the weld point 11 as the work target holds a qualification for performing the welding process under the welding condition for that weld point 11. Specifically, the qualification judgment module 202A acquires a holding qualification registered in the welder table 2110 for the welder ID included in the welding process start notification, and also acquires a required qualification registered in the welding process target record of the weld point table 211A. The qualification judgment module 202A then compares the holding qualification of the welder 50A and the required qualification for the weld point 11 with each other to judge eligibility of qualification described above.

As a result, when the qualification judgment module 202A judges that the holding qualification of the welder 50A is eligible with respect to the required qualification for the weld part 11 (Step S120: eligible), the welding process registration module 200 registers welder qualification judgment data indicating that the qualification is “eligible” in the welding process target record in Step S121, and the process proceeds to Step S130.

Meanwhile, when the qualification judgment module 202A judges that the holding qualification of the welder 50A is ineligible with respect to the required qualification for the weld point 11 (Step S120: ineligible), the welding process registration module 200 registers welder qualification judgment data indicating that the qualification is “ineligible” in the welding process target record in Step S122. Then, in Step S123, the welding process support module 203 performs qualification ineligibility processing to be performed when the holding qualification of the welder 50A is ineligible. Specifically, the welding process support module 203 transmits a notification that the holding qualification of the welder 50A is “ineligible” to, for example, the welder's terminal 5A of the welder 50A and the welding manager's terminal 5B of the welding manager 50B who manages that welder 50A. Further, the welding process support module 203 transmits a switch control instruction to place the switch 620 connected to the welding machine 6 to be used in a cut-off state to the distribution board 62. When receiving that notification, the welder 50A and the welding manager 50B reconfirm the holding qualification, and the switch 620 is turned off, and thus use of the welding machine 6 is prohibited. Therefore, execution of the welding process by an unqualified person can be prevented.

Next, in Step S130, the welding process support module 203 transmits the welding condition registered in the welding process target record of the weld point table 211A to the welder's terminal 5A.

Next, in Step S131, when receiving the welding condition from the welding data processing device 2, the welder's terminal 5A displays a preheating support screen based on the received welding condition. In Step S132, the welder 50A measures the temperature of the weld point 11 through use of the temperature measurement device 61, while preheating the weld point 11 through use of a welding preheating device (not shown) in accordance with the display content (for example, preheating in the welding condition) displayed on the preheating support screen. Then, in Step S133, the temperature measurement device 61 transmits preheating data 13 in which the measured temperature is recorded as the preheating state of the weld point 11 to the welding data processing device 2.

Next, in Step S140, when the welding data processing device 2 receives the preheating data 13 from the temperature measurement device 61, the welding process registration module 200 registers the preheating data 13 in the welding process target record.

Next, in Step S141, the deviation judgment module 202B refers to the welding process database 211 and judges whether the preheating data 13 received from the temperature measurement device 61 deviates beyond a preheating deviation judgment criterion with respect to the welding condition (preheating) registered in the welding process target record of the weld point table 211A. In the case in which, for example, a preheating temperature or a preheating time is determined as preheating in the welding condition, the deviation judgment module 202B compares, for example, a preheating temperature or a preheating time indicated by the preheating data 13 with the preheating temperature or the preheating time in the welding condition and, when the difference between the indicated preheating temperature or preheating time and the preheating temperature or the preheating time in the welding condition exceeds the preheating deviation judgment criterion (a predetermined threshold value), judges that the preheating data 13 deviates.

When the deviation judgment module 202B judges that the preheating data 13 does not deviate (Step S141: no deviation), the welding process registration module 200 registers preheating deviation judgment data indicating “no deviation” in the welding process target record in Step S142, and the process proceeds to Step S150.

Meanwhile, when the deviation judgment module 202B judges that the preheating data 13 deviates (Step S141: deviation found), the welding process registration module 200 registers preheating deviation judgment data indicating “deviation found” in the welding process target record in Step S143. In Step S144, the welding process support module 203 then performs preheating deviation processing to be performed when the preheating data 13 deviates. Specifically, the welding process support module 203 transmits a notification of “deviation found” to, for example, the welder's terminal 5A of the welder 50A and the welding manager's terminal 5B of the welding manager 50B who manages that welder 50A. Further, the welding process support module 203 transmits a switch control instruction to place the switch 620 connected to the welding machine 6 to be used in a cut-off state to the distribution board 62. The welder 50A and the welding manager 50B perform preheating again when receiving that notification, the switch 620 is turned off, and use of the welding machine 6 is prohibited, and hence the weld quality can be improved.

The preheating deviation judgment data may include not only the presence or absence of deviation but also, as detailed data of the deviation, the amount of deviation of the preheating data 13 with respect to the welding condition. The amount of deviation includes, for example, the amount of deviation of preheating temperature (for example, a difference value or a ratio) with respect to the preheating temperature in the welding condition as a reference.

Next, in Step S150, the welding process support module 203 transmits the welding condition registered in the welding process target record of the weld point table 211A to the welder's terminal 5A.

Next, in Step S151, when receiving the welding condition from the welding data processing device 2, the welder's terminal 5A displays a welding support screen based on the welding condition. In Step S152, the welder 50A operates the operation control panel 65 of the welding machine 6 in accordance with the display content (for example, electrical characteristics and a welding method in the welding condition) displayed on the welding support screen. Then, when the welder 50A brings the welding torch 63 close to the weld point 11 and turns on the switch 632, welding of the weld point 11 is performed. At this time, in Step S153, the welding machine monitoring device 60 records the operating state of the welding machine 6 and transmits welding machine operation data 12 in which the operating state is recorded to the welding data processing device 2.

Next, in Step S160, when the welding data processing device 2 receives the welding machine operation data 12 from the welding machine monitoring device 60, the welding process registration module 200 registers the received welding machine operation data 12 in the welding process target record. At this time, the welding process registration module 200 registers the date and time when the operating state of the welding machine 6 ends in the welding machine operation data 12 as execution end date and time in the welding process target record.

Next, in Step S161, the deviation judgment module 202B refers to the welding process database 211 and judges whether the welding machine operation data 12 received from the welding machine monitoring device 60 deviates beyond a welding deviation judgment criterion with respect to the welding condition (at least one of a welding current, a welding voltage, a welding speed, a welding direction, or a welding angle) registered in the welding process target record of the weld point table 211A. The deviation judgment module 202B compares, for example, a welding current, a welding voltage, a welding speed, a welding direction, and a welding angle indicated by the welding machine operation data 12 with the welding current, the welding voltage, the welding speed, the welding direction, and the welding angle in the welding condition, respectively, and, when at least one of the differences between those values exceeds the welding deviation judgment criterion (a predetermined threshold value), judges that the welding machine operation data 12 deviates.

When the deviation judgment module 202B judges that the welding machine operation data 12 does not deviate (Step S161: no deviation), the welding process registration module 200 registers welding deviation judgment data indicating “no deviation” in the welding process target record in Step S162, and the series of steps of processing is ended.

Meanwhile, when the deviation judgment module 202B judges that the welding machine operation data 12 deviates (Step S161: deviation found), the welding process registration module 200 registers welding deviation judgment data indicating “deviation found” in the welding process target record in Step S163. In Step S164, the welding process support module 203 then performs welding deviation processing to be performed when the welding machine operation data 12 deviates. Specifically, the welding process support module 203 transmits a notification of “deviation found” to, for example, the welder's terminal 5A of the welder 50A and the welding manager's terminal 5B of the welding manager 50B who manages the welder 50A. The welder 50A and the welding manager 50B determine necessity of repair welding or re-welding, priority of a radiographic test, or the like when receiving the notification, and hence it is possible to speed up decision-making and improve the weld quality.

The welding deviation judgment data may include not only the presence or absence of deviation but also, as detailed data of the deviation, the amount of deviation of the welding machine operation data 12 with respect to the welding condition. The amount of deviation includes, for example, the amount of deviation (a difference value, a ratio, or the like) of a welding voltage with respect to a welding voltage in the welding condition as a reference, the amount of deviation (a difference value, a ratio, or the like) of a welding current with respect to a welding current in the welding condition as a reference, the amount of deviation (a difference value, a ratio, or the like) of a welding speed with respect to a welding speed in the welding condition as a reference, the amount of deviation (a difference value, a ratio, or the like) of a welding direction with respect to a welding direction in the welding condition as a reference, or the amount of deviation (a difference value, a ratio, or the like) of a welding angle with respect to a welding angle in the welding condition as a reference.

The welding process is performed at each weld point 11 in the above-mentioned manner, and thus the welding execution record including the welding machine operation data 12 and the preheating data 13 is recorded in the welding process database 211 (specifically, in each welding process target record corresponding to the weld point 11) at any time and accumulated.

(3) Registration of Inspection Execution Record in Imaging Process

The inspection process registration module 201 performs registration processing of registering an inspection execution record in the inspection process database 212 in association with execution of an imaging process included in a radiographic test process. In conjunction with this registration processing, the qualification judgment module 202A performs qualification judgment processing for a holding qualification of the imaging worker 50C.

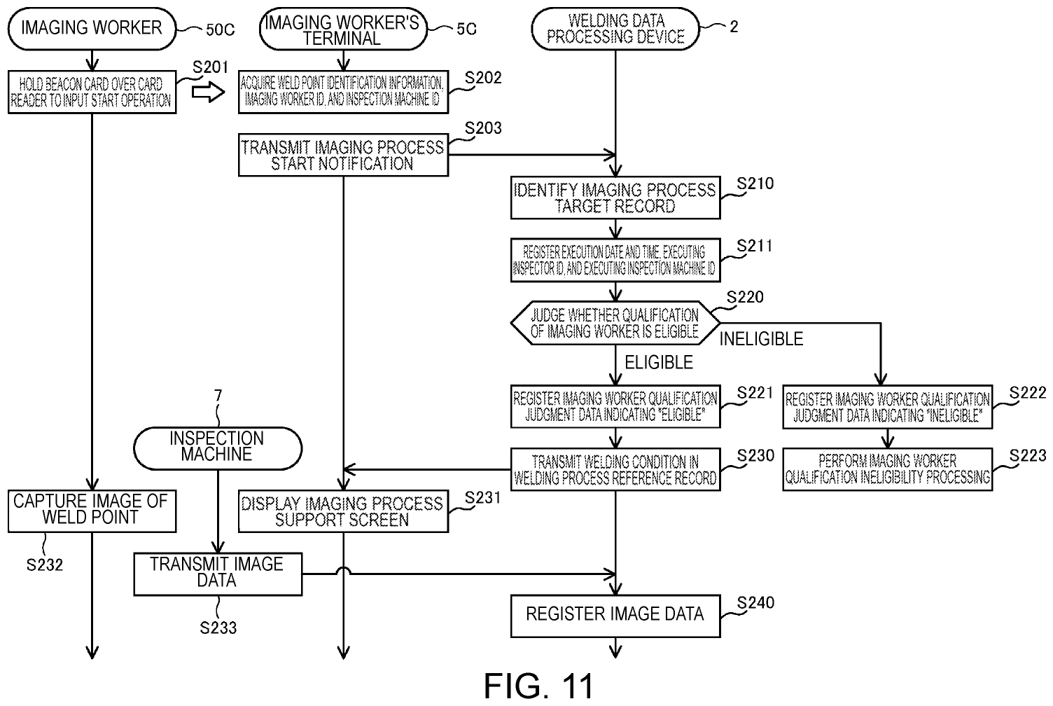

FIG. 11 is a flowchart of an example of the registration processing and the qualification judgment processing in the imaging process included in the radiographic test process. In FIG. 11, an operation after the imaging worker 50C, who is to perform the imaging process, moves to a weld point 11 as a work target and installs the inspection machine 7 to be used at the weld point 11 as the work target is described.

First, in Step S201, the imaging worker 50C inputs a welding site ID, a welding area ID, a drawing number, and a weld point number to the imaging worker's terminal 5C as weld point identification information for identifying the weld point 11 as the work target, and performs an imaging process start operation indicating the start of the imaging process. At this time, the imaging worker 50C holds the beacon card 31 thereof over the card reader 51.

Next, in Step S202, the imaging worker's terminal 5C receives the imaging process start operation to acquire the weld point identification information. The imaging worker's terminal 5C acquires an imaging worker ID for identifying the imaging worker 50C by reading card information from the beacon card 31 of the imaging worker 50C with the card reader 51. The imaging worker's terminal 5C acquires an inspection machine ID for identifying the inspection machine 7 by reading card information from the beacon card 31 attached to the inspection machine 7 to be used with the card reader 51. The imaging worker's terminal 5C may acquire the inspection machine ID from the construction progress management device 3.

Next, in Step S203, the imaging worker's terminal 5C transmits an imaging process start notification including the weld point identification information, the imaging worker ID, and the inspection machine ID to the welding data processing device 2.

Next, in Step S210, when the welding data processing device 2 receives the imaging process start notification from the imaging worker's terminal 5C, the inspection process registration module 201 refers to the inspection process database 212 to identify a record corresponding to the weld point identification information included in the imaging process start notification (hereinafter referred to as “imaging process target record”) in the weld point table 212A. In Step S211, the inspection process registration module 201 then registers reception date and time of the imaging process start notification as imaging date and time in the imaging process target record. In addition, the inspection process registration module 201 registers the imaging worker ID included in the imaging process start notification as an executing imaging worker ID in the imaging process target record and also registers the inspection machine ID included in the imaging process start notification as an executing inspection machine ID in the imaging process target record.

Next, in Step S220, the qualification judgment module 202A refers to the inspection process database 212 and judges eligibility of qualification, that is, whether the imaging worker 50C who is to perform the imaging process at the weld point 11 as the work target holds a qualification for performing the imaging process for the weld point 11. Specifically, the qualification judgment module 202A acquires a holding qualification registered in the imaging worker table 212C for the imaging worker ID included in the imaging process start notification, and also acquires an imaging worker required qualification registered in the imaging process target record of the weld point table 212A. The qualification judgment module 202A then compares the holding qualification of the imaging worker 50C and the imaging worker required qualification for the weld point 11 with each other to judge eligibility of qualification described above.

As a result, when the qualification judgment module 202A judges that the holding qualification of the imaging worker 50C is eligible with respect to the imaging worker required qualification for the weld part 11 (Step S220: eligible), the inspection process registration module 201 registers imaging worker qualification judgment data indicating that the qualification is “eligible” in the imaging process target record in Step S211, and the process proceeds to Step S230.

Meanwhile, when the qualification judgment module 202A judges that the holding qualification of the imaging worker 50C is ineligible with respect to the imaging worker required qualification for the weld point 11 (Step S220: ineligible), the inspection process registration module 201 registers imaging worker qualification judgment data indicating that the qualification is “ineligible” in the imaging process target record in Step S222. In Step S223, the inspection process support module 204 then performs qualification ineligibility processing to be performed when the holding qualification of the imaging worker 50C is ineligible. Specifically, the inspection process support module 204 transmits a notification indicating that the qualification is “ineligible” to, for example, the imaging worker's terminal 5C of the imaging worker 50C and the inspection manager's terminal 5E of the inspection manager 50E who manages the imaging worker 50C. The imaging worker 50C and the inspection manager 50E reconfirm the holding qualification when receiving that notification, and hence execution of the imaging process by an unqualified person can be prevented.

Next, in Step S230, the inspection process support module 204 refers to the welding process database 211, identifies a record corresponding to the weld point identification information included in the imaging process start notification (hereinafter referred to as “welding process reference record”) of the weld point table 211A, and acquires a welding condition registered in the identified welding process reference record. The inspection process support module 204 then transmits the acquired welding condition to the imaging worker's terminal 5C.

Next, in Step S231, when receiving the welding condition from the welding data processing device 2, the imaging worker's terminal 5C displays an imaging process support screen based on the welding condition. In Step S232, the imaging worker 50C operates the operation control panel 74 of the inspection machine 7 while referring to the display content (for example, diameter, thickness, material, joint shape, and welding material in the welding condition) displayed on the imaging process support screen, and sets operation parameters of the radiation irradiation unit 70, the detector 71, and the driving unit 73. Then, when the imaging worker 50C performs an imaging start operation on the operation control panel 74, the inspection machine 7 captures an image of the weld point 11 over the entire circumference to generate image data 14 in Step S233. The inspection machine 7 then transmits the image data 14 to the welding data processing device 2.

Next, in Step S240, when the welding data processing device 2 receives the image data 14 from the inspection machine 7, the inspection process registration module 201 registers the image data 14 in the imaging process target record, and the series of steps of processing is ended.

The imaging process is performed at each weld point 11 in the above-mentioned manner, and thus the inspection execution record including the image data 14 is registered in the inspection process database 212 (specifically, in the imaging process target records corresponding to the respective weld points 11) at any time and accumulated.

(4) Registration of Inspection Execution Record in Image Judgment Process

The inspection process registration module 201 performs registration processing of registering the inspection execution record in the inspection process database 212 in association with execution of the image judgment process included in the radiographic test process. In conjunction with this registration processing, the qualification judgment module 202A performs qualification judgment processing for a holding qualification of the judge 50D.

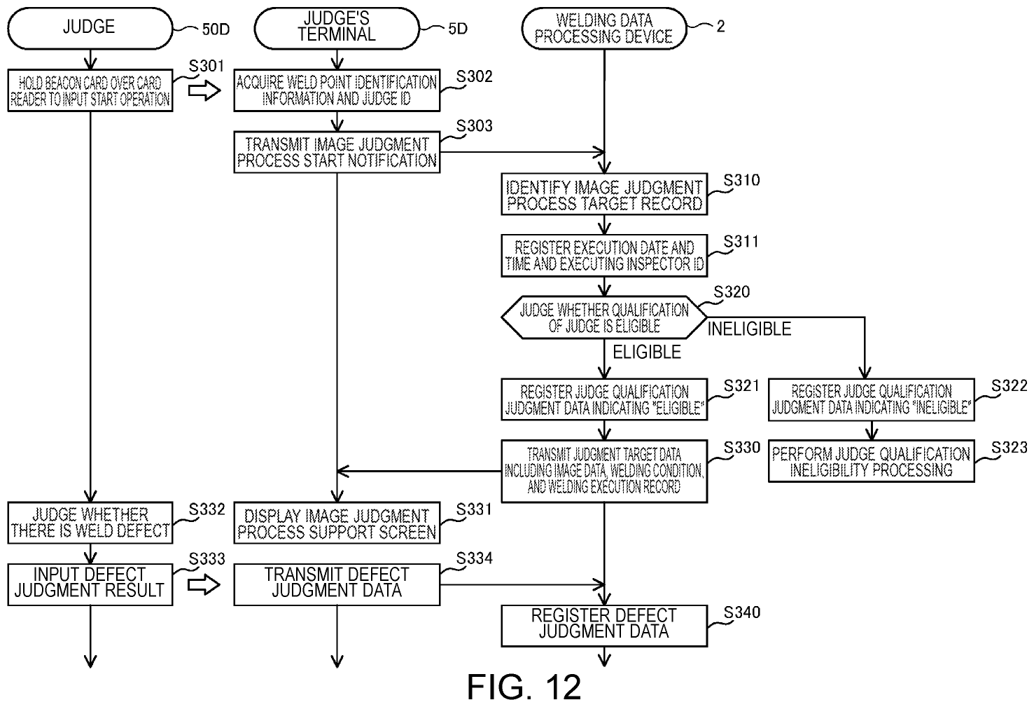

FIG. 12 is a flowchart of an example of the registration processing and the qualification judgment processing in the image judgment process included in the radiographic test process. In FIG. 12, an operation in the case in which the judge 50D, who is to perform the image judgment process, performs work at a location different from the weld point 11 is described.

First, in Step S301, the judge 50D inputs a welding site ID, a welding area ID, a drawing number, and a weld point number to the judge's terminal 5D as weld point identification information for identifying the weld point 11 as a work target, and performs an image judgment process start operation indicating the start of the judgment process. At this time, the judge 50D holds the beacon card 31 thereof over the card reader 51.

Next, in Step S302, the judge's terminal 5D receives the image judgment process start operation to acquire the weld point identification information. The judge's terminal 5D acquires a judge ID for identifying the judge 50D by reading card information from the beacon card 31 of the judge 50D with the card reader 51.

Next, in Step S303, the judge's terminal 5D transmits an image judgment process start notification including the weld point identification information and the judge ID to the welding data processing device 2.

Next, in Step S310, when the welding data processing device 2 receives the image judgment process start notification from the judge's terminal 5D, the inspection process registration module 201 refers to the inspection process database 212 and identifies a record corresponding to the weld point identification information included in the image judgment process start notification (hereinafter referred to as “image judgment process target record”) in the weld point table 212A. Moreover, in Step S311, the inspection process registration module 201 registers reception date and time of the image judgment start notification as image judgment date and time in the image judgment process target record and also registers the judge ID included in the image judgment process start notification as an executing judge ID in the image judgment process target record.

Next, in Step S320, the qualification judgment module 202A refers to the inspection process database 212 and judges eligibility of qualification, that is, whether the judge 50D who performs the image judgment process at the weld point 11 as the work target holds a qualification for performing the image judgment process at that weld point 11. Specifically, the qualification judgment module 202A acquires the holding qualification registered in the judge table 212D for the judge ID included in the image judgment process start notification and also acquires a judge required qualification registered in the image judgment process target record of the weld point table 212A. The qualification judgment module 202A then compares the holding qualification of the judge 50D and the judge required qualification for the weld point 11 with each other to judge eligibility of qualification described above.

As a result, when the qualification judgment module 202A judges that the holding qualification of the judge 50D is eligible with respect to the judge required qualification for the weld point 11 (Step S320: eligible), the inspection process registration module 201 registers judge qualification judgment data indicating that the qualification is “eligible” in the image judgment process target record in Step S321, and the process proceeds to Step S330.

Meanwhile, when the qualification judgment module 202A judges that the holding qualification of the judge 50D is ineligible with respect to the judge required qualification for the weld point 11 (Step S320: ineligible), the inspection process registration module 201 registers judge qualification judgment data indicating that the qualification is “ineligible” in the image judgment process target record in Step S322. In Step S323, the inspection process support module 204 then performs qualification ineligibility processing to be performed when the holding qualification of the judge 50D is ineligible. Specifically, the inspection process support module 204 transmits a notification indicating that the qualification is “ineligible” to, for example, the judge's terminal 5D of the judge 50D and the inspection manager's terminal 5E of the inspection manager 50E who manages the judge 50D. The judge 50D and the inspection manager 50E reconfirm the holding qualification when receiving that notification, and hence execution of the image judgment process by an unqualified person can be prevented.

Next, in Step S330, the inspection process support module 204 acquires the image data 14 registered in the image judgment process target record of the weld point table 212A. Further, the inspection process support module 204 refers to the welding process database 211, identifies a record corresponding to the weld point identification information included in the image judgment process start notification (hereinafter referred to as “welding process reference record”) of the weld point table 211A, and acquires the welding condition and the welding execution record registered in the identified welding process reference record. The inspection process support module 204 then transmits judgment target data including the image data 14, the welding condition, and the welding execution record thus acquired to the judge's terminal 5D.

Next, in Step S331, when receiving the judgment target data from the welding data processing device 2, the judge's terminal 5D displays an image judgment process support screen based on the judgment target data. In Step S332, the judge 50D checks the image data 14 displayed on the image judgment process support screen with eyes to judge whether there is a weld defect at the weld point 11. At this time, the judge 50D can refer to the contents of the welding condition and the welding execution record displayed on the image judgment process support screen. Then, when the judge 50D performs a defect judgment result input operation of inputting the result of judgment of whether there is a weld defect on the image judgment process support screen in Step S333, the judge's terminal 5D generates defect judgment data based on the defect judgment result input operation and transmits the defect judgment data to the welding data processing device 2 in Step S334.

Next, in Step S340, when the welding data processing device 2 receives the defect judgment data from the judge's terminal 5D, the inspection process registration module 201 registers the defect judgment data in the image judgment process target record, and the series of steps of processing is ended.

The image judgment process is performed at each weld point 11 in the above-mentioned manner, and thus the inspection execution record including the defect judgment data is registered in the inspection process database 212 (specifically, in image judgment process target records corresponding to the respective weld points 11) at any time and accumulated.

(5) Analysis of Defect Occurrence Tendency

The defect analysis module 202C performs defect analysis processing of analyzing a defect occurrence tendency based on information in each of records registered in the welding process database 211 and the inspection process database 212.

The defect analysis module 202C analyzes the defect occurrence tendency based on at least one of a welding condition or a welding execution record and defect judgment data, as the information in each record. At this time, the defect analysis module 202C receives a predetermined analysis condition and performs statistical processing in accordance with the analysis condition, to thereby analyze the defect occurrence tendency.

The defect occurrence tendency shows a tendency at the time when a weld defect has occurred at a weld point 11 and is represented by a statistical index value such as a mean value, a median value, a maximum value, a minimum value, a variance, a standard deviation, a ratio, and a frequency. The defect occurrence tendency is obtained by a statistical method such as grand total, cross tabulation, frequency distribution, Pareto analysis, matrix analysis, regression analysis, and factor analysis.

As the analysis condition, an analysis target range and an analysis axis, for example, are specified in addition to the statistical method and the statistical index value described above.

As for the analysis target range, a range of records to be analyzed by the defect analysis module 202C is specified among records registered in the welding process database 211 and the inspection process database 212. The analysis target range is specified by, for example, location, period, workers 50A to 50E, work time, department, welding condition, welding execution record, presence or absence of a weld defect, defect detail status, welding machine 6, or inspection machine 7, or a combination thereof. The analysis target range is specified by, for example, a variable/variables in one or a plurality of fields included in each of the tables 211A to 221D of the welding process database 211 and the tables 212A to 222E of the inspection process database 212. Specifying the analysis target range may be omitted.

For example, when at least one of a welding site ID or a welding area ID of the weld point table 211A is specified as the analysis target range, the defect analysis module 202C extracts a record matching the welding site 10 and the welding area thus specified as the analysis target. When a period (for example, past one week, one month, or one year) is specified as the analysis target range, the defect analysis module 202C extracts a record matching the specified period as the analysis target. When at least one of an executing welder ID of the weld point table 211A, a welding manager ID of the welding manager table 211D, or a department ID of the welding manager table 211D is specified as the analysis target range, the defect analysis module 202C extracts a record matching the at least one of the executing welder ID, the welding manager ID, or the department ID thus specified as the analysis target. When a work time based on execution start date and time and execution end date and time (for example, a real work time (a time from the execution start date and time to the execution end date and time), a waiting time before work (a time from the execution end date and time of previous welding to the execution start date and time of current welding), and a work time zone (after meal, after rest, shift zone, or the like)) is specified as the analysis target range, the defect analysis module 202C extracts a record matching the specified period as the analysis target. When at least one of fields (diameter, thickness, material (base material), joint shape, welding material, preheating, post-weld heat treatment, shielding gas, welding current, welding voltage, welding speed, welding direction, welding angle, and arc time) included in a welding condition of the weld point table 211A and a variable for the at least one field are specified as the analysis target range, the defect analysis module 202C extracts a record matching the specified variable for the field as the analysis target. When at least one of fields (preheating data 13, welding machine operation data 12, preheating deviation judgment data, and welding deviation judgment data) included in a welding execution record of the weld point table 211A and a variable for the at least one field are specified as the analysis target range, the defect analysis module 202C extracts a record matching the specified variable for the field as the analysis target. In this case, the analysis target range may be specified by detailed data included in any of the preheating data 13, the welding machine operation data 12, the preheating deviation judgment data, and the welding deviation judgment data.

The analysis axis specifies a field to be used when the defect analysis module 202C analyzes a plurality of records included in the analysis target range by a predetermined statistical method. The analysis axis is specified by, for example, location, period, workers 50A to 50E, work time, department, welding condition, welding execution record, presence or absence of a weld defect, defect detail status, welding machine 6, or inspection machine 7, or a combination thereof. The analysis axis is specified by, for example, one or a plurality of fields included in each of the tables 211A to 221D of the welding process database 211 and the tables 212A to 222E of the inspection process database 212. Specifying the analysis axis may be omitted.

For example, when at least one of a welding site ID or a welding area ID of the weld point table 211A is specified as the analysis axis, the defect analysis module 202C analyzes a defect occurrence tendency with respect to at least one of the welding site 10 or the welding area thus specified as the analysis axis. When a period (for example, on daily basis, on weekly basis, or on monthly basis) is specified as the analysis axis, the defect analysis module 202C analyzes the defect occurrence tendency with respect to the specified period as the analysis axis. When at least one of an executing welder ID of the weld point table 211A or a welding manager ID and a department ID of the manager table 211D is specified as the analysis axis, the defect analysis module 202C analyzes the defect occurrence tendency with respect to at least one of the welder 50A, the welding manager 50B, or the department thus specified as the analysis axis. When a work time based on the execution start date and time and the execution end date and time (for example, a real work time, a waiting time before work, or a work time zone) is specified as the analysis axis, the defect analysis module 202C analyzes the defect occurrence tendency with respect to the specified work time as the analysis axis. When at least one of fields (diameter, thickness, material (base material), joint shape, welding material, preheating, post-weld heat treatment, shielding gas, welding current, welding voltage, welding speed, welding direction, welding angle, and arc time) included in a welding condition of the weld point table 211A is specified as the analysis axis, the defect analysis module 202C analyzes the defect occurrence tendency with respect to the at least one field thus specified as the analysis axis. When at least one of fields (preheating data 13, welding machine operation data 12, preheating deviation judgment data, and welding deviation judgment data) included in a welding execution record of the weld point table 211A is specified as the analysis axis, the defect analysis module 202C analyzes the defect occurrence tendency with respect to the at least one field thus specified as the analysis axis. At this time, the analysis axis may be specified by detailed data included in any of the preheating data 13, the welding machine operation data 12, the preheating deviation judgment data, and the welding deviation judgment data.

As the analysis condition, an analysis frequency at which the defect occurrence tendency is regularly analyzed and the analysis result is regularly notified, or a notification condition for notifying the result of analysis of the defect occurrence tendency, such as when a defect occurrence ratio is higher than a predetermined value, may be specified.

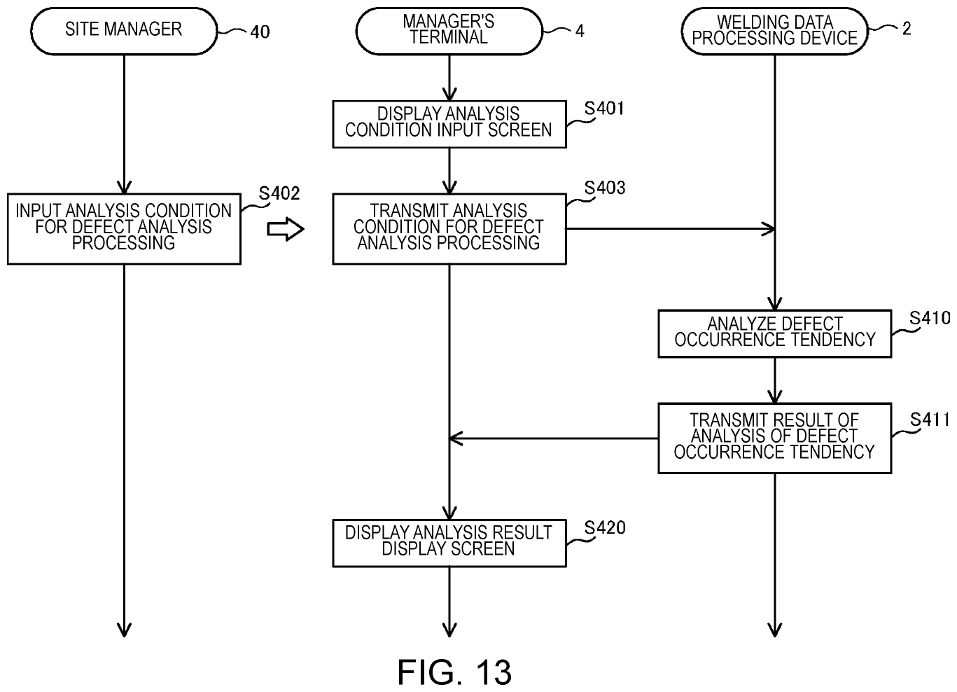

FIG. 13 is a flowchart of an example of the defect analysis processing. FIG. 13 shows an operation in the case in which the defect analysis module 202C receives an analysis condition in the defect analysis processing from the manager's terminal 4 and analyzes the defect occurrence tendency in accordance with the analysis condition.

First, in Step S401, when receiving an operation for requesting the defect analysis processing from the site manager 40, the manager's terminal 4 displays an analysis condition input screen 42. When the site manager 40 performs an analysis condition input operation of inputting an analysis condition on the analysis condition input screen 42 in Step S402, the manager's terminal 4 receives the analysis condition and transmits the received analysis condition to the welding data processing device 2 in Step S403.

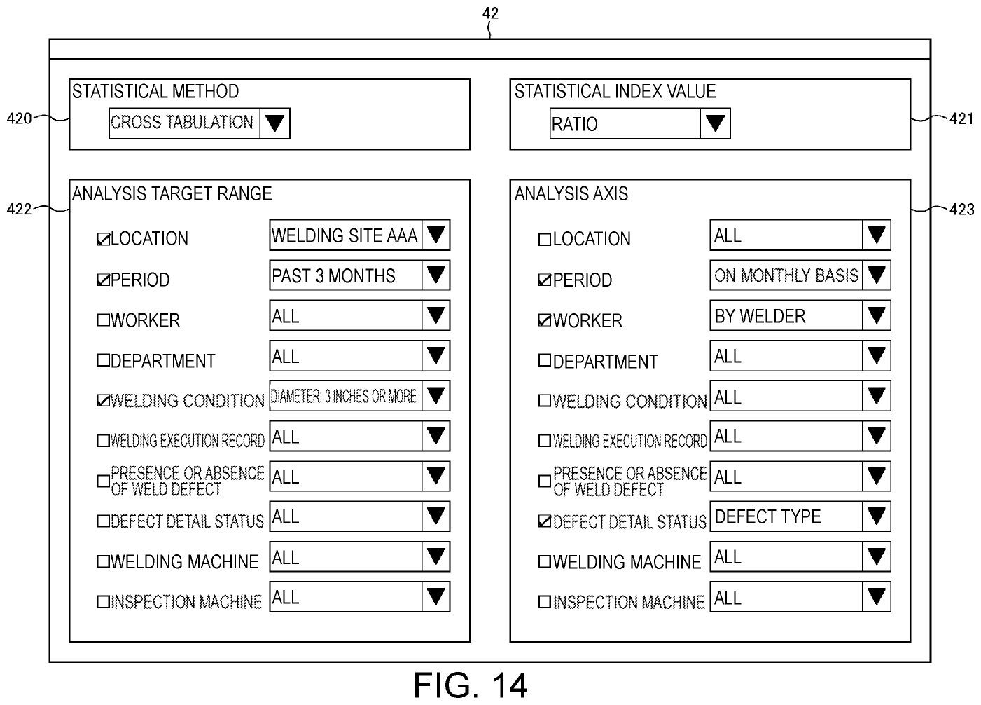

FIG. 14 is a diagram of an example of the analysis condition input screen 42. The analysis condition input screen 42 includes input fields 420 to 423 for specifying the analysis condition to be used when the defect analysis module 202C analyzes the defect occurrence tendency.

In the analysis condition input screen 42 illustrated in FIG. 14, “cross tabulation” is specified in the statistical method input field 420; “ratio” is specified in the statistical index value input field 421; location “weld site AAA,” period “past three months,” and weld condition “diameter: 3 inches or more” are specified in the analysis target range input field 422; and period “on monthly basis,” worker “by welder,” and defect detail status “defect type” are specified in the analysis axis input field 423.

Returning to FIG. 13, when the welding data processing device 2 receives the analysis condition from the manager's terminal 4, in Step S410, the defect analysis module 202C analyzes the defect judgment tendency in accordance with the received analysis condition. Specifically, the defect analysis module 202C extracts a record matching the analysis target range specified as the analysis condition from the weld point table 211A of the welding process database 211 and the weld point table 212A of the inspection process database 212.

In the case in which the analysis condition is specified as illustrated in FIG. 14, a record in which the welding site ID is “welding site AAA,” the execution start date and time is within “past three months,” and the diameter in the welding condition is “3 inches or more” are extracted in the weld point table 211A.

The defect analysis module 202C then performs statistical processing for the extracted records in accordance with the statistical method, the statistical index value, and the analysis axis specified as the analysis condition, to thereby derive the analysis result of the defect judgment tendency. In the case in which the analysis condition is specified as illustrated in FIG. 14, “cross tabulation” is performed with regard to “ratio” by using three analysis axes: period “on monthly basis”; worker “by welder”; and defect detail status “defect type”.

Next, in Step S411, the output processing module 205 transmits the analysis result of the defect judgment tendency to the manager's terminal 4. In Step S420, when receiving the analysis result of the defect judgment tendency from the welding data processing device 2 as a response to the analysis condition, the manager's terminal 4 displays an analysis result display screen 43 based on the received analysis result.

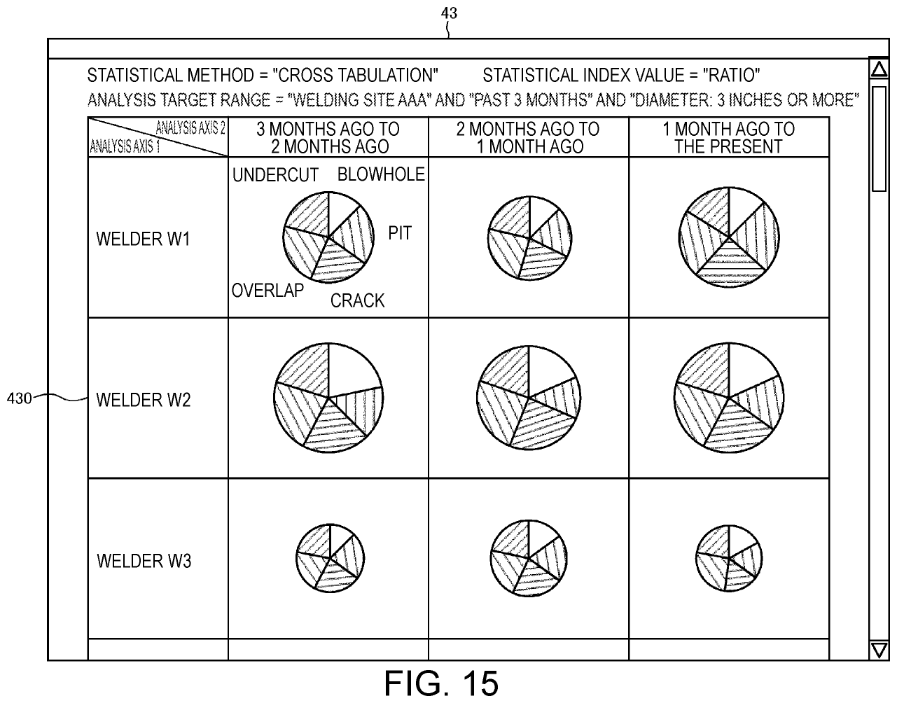

FIG. 15 is a diagram of an example of the analysis result display screen 43 in the defect analysis processing. The analysis result display screen 43 includes a display region 430 for displaying the defect occurrence tendency that is the result of analysis by the defect analysis module 202C in a predetermined tabular form or graphical format.

The analysis result display screen 43 illustrated in FIG. 15 is a screen to be displayed in the case in which the analysis condition is specified as illustrated in FIG. 14. Therefore, the analysis result obtained by performing “cross tabulation” through use of three analysis axes of “by welder,” “on monthly basis,” and “defect type” is shown in a pie chart format in the display region 430. In the pie chart, a defect occurrence ratio for each “defect type” is expressed, and the frequency is expressed by the magnitude of the defect occurrence ratio. The analysis result display screen 43 may be configured to allow the tabular form or the graphical format to be changed. Moreover, the analysis result display screen 43 may have a button for causing the analysis condition input screen 42 to be displayed and, when the analysis condition is changed, display the analysis result based on the changed analysis condition.

When the average value, the lowest temperature, or the highest temperature of the preheating temperature or the preheating time included in the preheating data 13 of the welding execution record, for example, is specified as the analysis axis as another analysis condition, the analysis result of the defect judgment tendency for the values thus specified is derived and displayed. Moreover, when the deviation amount included in the preheating deviation judgment data (the deviation amount of preheating temperature) or the deviation amount included in the welding deviation judgment data (the deviation amount of welding voltage, the deviation amount of welding current, the deviation amount of welding speed, the deviation amount of welding direction, or the deviation amount of welding angle) is specified as the analysis axis, the analysis result of the defect judgment tendency for the deviation amount thus specified is derived and displayed. Further, when a work time based on the execution start date and time and the execution end date and time (a real work time, a waiting time before work, or a work time zone) is specified as the analysis axis, the analysis result of the defect judgment tendency for the work time thus specified is derived and displayed.

As described above, the defect analysis module 202C analyzes the defect occurrence tendency based on information registered in the welding process database 211 and the inspection process database 212. While referring to the analysis result of the defect occurrence tendency, the site manager 40 (who may be any of the workers 50A to 50E) can investigate the situation and cause of the occurrence of a weld defect, find out the situation and cause at an early stage, and reflect the findings in education and guidance to the workers 50A to 50E and assignment of the workers 50A to 50E to each weld point 11, for example. Therefore, the weld quality and the productivity can be improved.

(6) Analysis of Qualification Ineligibility Occurrence Tendency

The qualification ineligibility analysis module 202D performs qualification ineligibility analysis processing of analyzing a tendency of qualification ineligibility occurrence regarding the holding qualification of each of the workers 50A to 50E based on information in each record registered in the welding process database 211 and the inspection process database 212. When the qualification held by any of the workers 50A to 50E is ineligible with respect to the qualification required for the weld point 11, the qualification ineligibility processing in Step S123, Step S223, or Step S323 is performed, and thus the work by the unqualified one of the workers 50A to 50E is prevented. Therefore, the qualification ineligibility analysis processing by the qualification ineligibility analysis module 202D assumes to analyze a situation in which any of the workers 50A to 50E has erroneously performed the work although that worker is unqualified.

The qualification ineligibility analysis module 202D analyzes the tendency of qualification ineligibility occurrence based on at least one of a welding condition or a welding execution record and welder qualification judgment data, as the information in each record. In this analysis, the qualification ineligibility analysis module 202D receives a predetermined analysis condition and performs statistical processing in accordance with the analysis condition, to thereby analyze the tendency of qualification ineligibility occurrence, as with the defect analysis module 202C. The tendency of qualification ineligibility occurrence shows an occurrence tendency of ineligibility at the time when the holding qualification of the welder 50A and the required qualification for the weld point 11 are compared with each other, and can be represented by various statistical index values and obtained by various statistical methods, as with the defect occurrence tendency. Further, as for the analysis condition for the tendency of qualification ineligibility occurrence, a statistical method, a statistical index value, an analysis target range, and an analysis axis are specified, as with the analysis condition for the defect occurrence tendency.

The qualification ineligibility analysis module 202D may analyze, based on at least one of a welding condition, a welding execution record, or an inspection execution record and imaging worker qualification judgment data, the tendency of qualification ineligibility occurrence showing the occurrence tendency of ineligibility at the time when the holding qualification of the imaging worker 50C and the required qualification for the weld point 11 are compared with each other. Further, the qualification ineligibility analysis module 202D may analyze, based on at least one of the welding condition, the welding execution record, or the inspection execution record and judge qualification judgment data, the tendency of qualification ineligibility occurrence showing the occurrence tendency of ineligibility at the time when the holding qualification of the judge 50D and the required qualification for the weld point 11 are compared with each other.

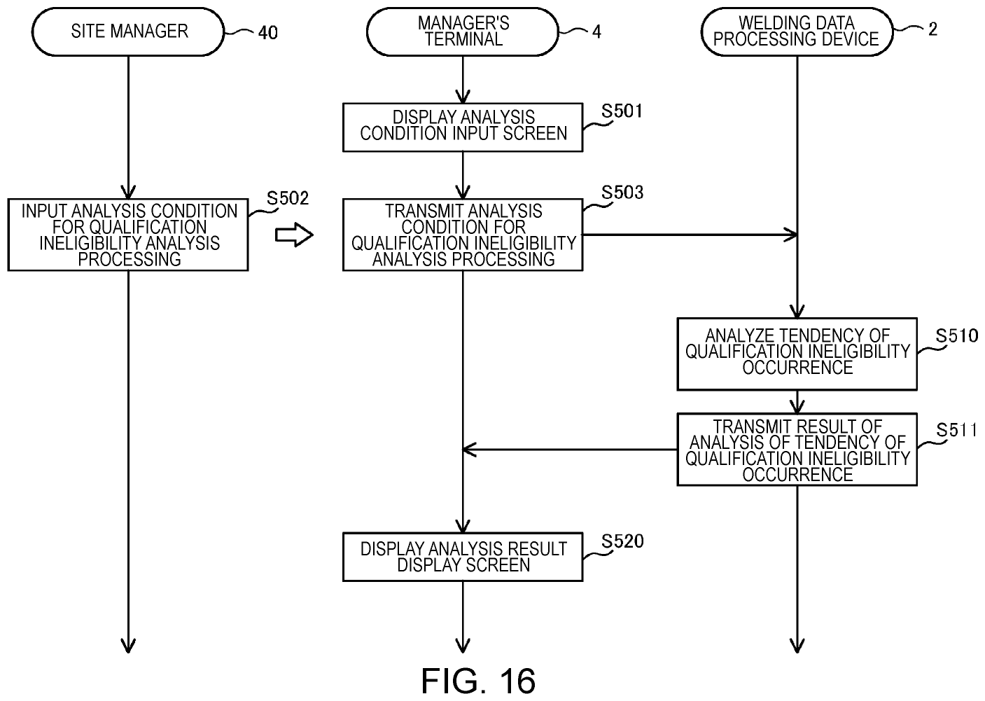

FIG. 16 is a flowchart of an example of the qualification ineligibility analysis processing. FIG. 16 shows an operation in the case in which the qualification ineligibility analysis module 202D receives an analysis condition in the qualification ineligibility analysis processing from the manager's terminal 4 and analyzes the tendency of qualification ineligibility occurrence in accordance with the received analysis condition. The basic operation is similar to the defect analysis processing illustrated in FIG. 13, and therefore the detailed description thereof is omitted.

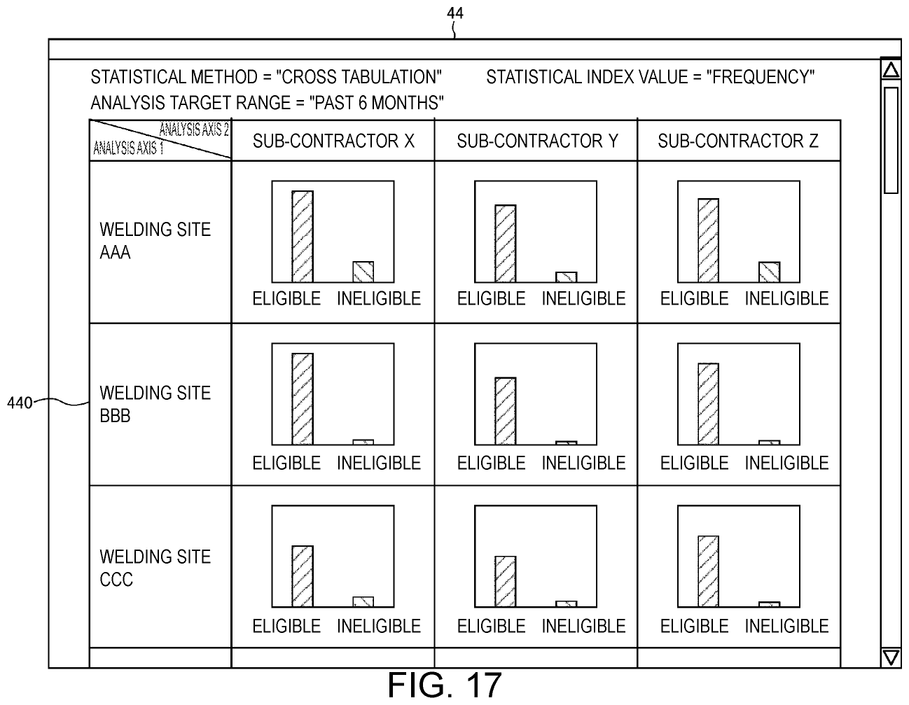

FIG. 17 is a diagram of an example of an analysis result display screen 44 in the qualification ineligibility analysis processing. The analysis result display screen 44 includes a display region 440 for displaying the tendency of qualification ineligibility occurrence, which is the result of analysis by the qualification ineligibility analysis module 202D, in a predetermined tabular form or graphical format. In the display region 440 illustrated in FIG. 17, the analysis result obtained by “cross tabulation” for judge qualification judgment data with respect to two analysis axes of “by welding site” and “by department” is shown in a bar chart format.

As described above, the qualification ineligibility analysis module 202D analyzes the tendency of qualification ineligibility occurrence based on information registered in the welding process database 211 and the inspection process database 212. While referring to the analysis result of the tendency of qualification ineligibility occurrence, the site manager 40 (who may be any of the workers 50A to 50E) can grasp, for example, the welder 50A who has erroneously performed the welding process without qualification, the welding manager 50B who manages that welder 50A, and the department to which that welder 50A belongs, and can perform education and guidance. Therefore, the weld quality and the productivity can be improved.

(7) Analysis of Deviation Occurrence Tendency

The deviation analysis module 202E performs deviation analysis processing of analyzing a deviation occurrence tendency regarding deviation of a welding execution record with respect to a welding condition based on information in each record registered in the welding process database 211 and the inspection process database 212.

The deviation analysis module 202E analyzes the deviation occurrence tendency based on at least one of the welding condition or the welding execution record and at least one of preheating deviation judgment data or welding deviation judgment data, as the information in each record. In this analysis, the deviation analysis module 202E receives a predetermined analysis condition and performs statistical processing in accordance with the analysis condition, to thereby analyze the deviation occurrence tendency, as with the defect analysis module 202C. The deviation occurrence tendency shows an occurrence tendency of deviation at the time when the welding execution record (the welding machine operation data 12 or the preheating data 13) and the welding condition for the weld point 11 are compared with each other, and can be represented by various statistical index values and obtained by various statistical methods, as with the defect occurrence tendency. Further, as for the analysis condition for the deviation occurrence tendency, a statistical method, a statistical index value, an analysis target range, and an analysis axis are specified, as with the analysis condition for the defect occurrence tendency.

The deviation judgment criterion setting module 202F sets a deviation judgment criterion to be used in judgment by the deviation judgment module 202B regarding whether deviation is present, based on the welding condition, the welding execution record, and defect judgment data. When setting a welding deviation judgment criterion, the deviation judgment criterion setting module 202F acquires, for example, the welding condition (the welding current and the welding voltage) and the welding machine operation data 12 that correspond to the weld point 11 registered as “non-defective” in the defect judgment data in the weld point table 212A of the inspection process database 212, from the weld point table 211A of the welding process database 211 and sets the welding deviation judgment criterion based on differences between the welding current and the welding voltage in the acquired welding condition and the welding machine operation data 12 (for example, the maximum value or the confidence interval). When setting a preheating deviation judgment criterion, the deviation judgment criterion setting module 202F acquires, for example, the welding condition (preheating) and the preheating data 13 that correspond to the weld point 11 registered as “non-defective” in the defect judgment data in the weld point table 212A of the inspection process database 212, from the weld point table 211A of the welding process database 211 and sets the preheating deviation judgment criterion based on a difference between the preheating in the acquired welding condition and the preheating data 13 (for example, the maximum value or the confidence interval).

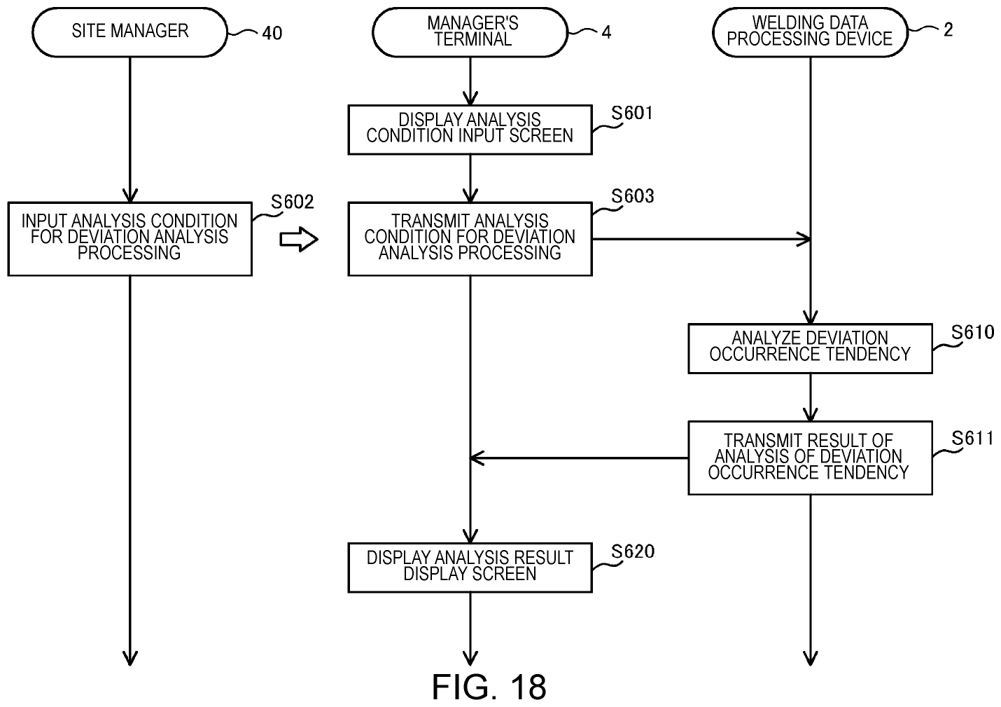

FIG. 18 is a flowchart of an example of the deviation analysis processing. FIG. 18 shows an operation in the case in which the deviation analysis module 202E receives an analysis condition in the deviation analysis processing from the manager's terminal 4 and analyzes the deviation occurrence tendency in accordance with the analysis condition. The basic operation is similar to the defect analysis processing illustrated in FIG. 13, and therefore the detailed description thereof is omitted.

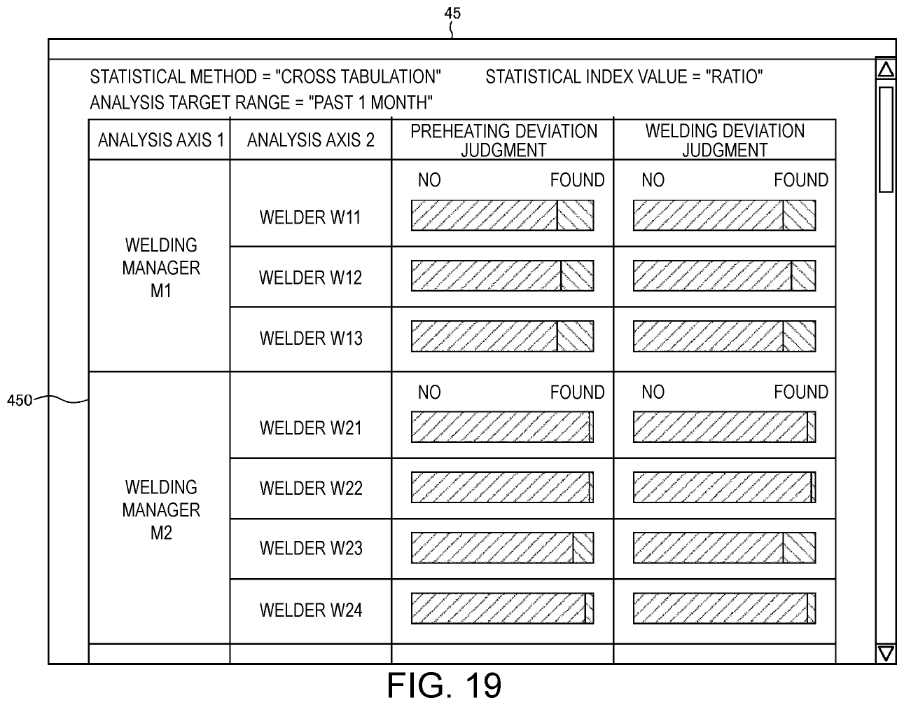

FIG. 19 is a diagram of an example of an analysis result display screen 45 in the deviation analysis processing. The analysis result display screen 45 includes a display region 450 for displaying the deviation occurrence tendency, which is the result of analysis by the deviation analysis module 202E, in a predetermined tabular form or graphical format. In the display region 450 illustrated in FIG. 19, the analysis result obtained by “cross tabulation” for preheating deviation judgment data and welding deviation judgment data with respect to two analysis axes of “by welding manager” and “by welder” is shown in a bar chart format.

As described above, the deviation analysis module 202E analyzes the deviation occurrence tendency based on information registered in the welding process database 211 and the inspection process database 212. While referring to the analysis result of the deviation occurrence tendency, the site manager 40 (who may be any of the workers 50A to 50E) can grasp, for example, the welder 50A who has performed the welding process under a state in which deviation occurs with respect to the welding condition for the weld point 11, the welding manager 50B who manages the welder 50A, and the department to which that welder 50A belongs, and can perform education and guidance. Therefore, the weld quality and the productivity can be improved.

(8) Welding Assist Function Before Welding Process, Using Defect Occurrence Tendency

The welding assist module 202G performs welding assist processing of generating assist information including a feature of the welding execution record for which a weld defect is predicted to occur at a weld point 11 as an assist target, based on the welding condition at the weld point 11 and the defect occurrence tendency obtained by analysis of information registered in the welding process database 211 and the inspection process database 212 performed by the defect analysis module 202C. The weld point 11 as the assist target may be any weld point 11 corresponding to a record in which a welding condition is registered in the weld point table 211A of the welding process database 211. Therefore, the welding assist processing is performed at any timing before a welding process is performed at the weld point as the assist target.

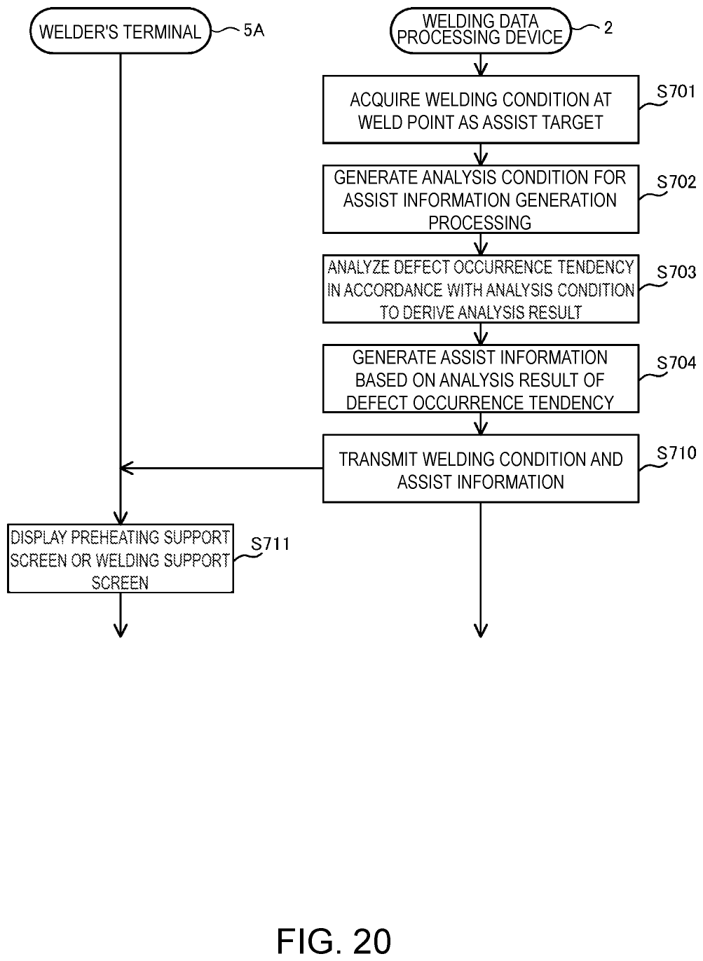

FIG. 20 is a flowchart of an example of the welding assist processing. FIG. 20 shows an operation in the case in which the welding assist module 202G transmits assist information by the welding assist processing in Step S130 of FIG. 9 or Step S150 of FIG. 10 and the assist information is displayed in Step S131 or Step S151.

First, in Step S701, the welding assist module 202G receives the weld point 11 identified by the welding process target record as the weld point 11 that is the assist target, to thereby acquire the welding condition registered in the welding process target record of the weld point table 211A.

Next, in Step S702, the welding assist module 202G generates an analysis condition for the defect analysis processing to be performed by the defect analysis module 202C, based on the welding condition at the weld point 11 as the assist target. As for the analysis condition here, for example, the minimum value exhibited when a weld defect has occurred by grand total is specified as a statistical method and a statistical index value; the same or predetermined similar range as/to the welding condition at the weld point 11 as the assist target is specified as an analysis target range; and the deviation amount included in the preheating deviation judgment data or the deviation amount included in the welding deviation judgment data is specified as an analysis axis.

Next, in Step S703, the defect analysis module 202C analyzes the defect occurrence tendency under the analysis condition generated by the welding assist module 202G to derive the analysis result. In the example of the above-mentioned analysis condition, the defect analysis module 202C extracts a record with a welding condition that is the same as or within a predetermined similar range to the welding condition at the weld point 11 as the assist target, from the weld point table 211A of the welding process database 211 and the weld point table 212A of the inspection process database 212. The defect analysis module 202C then refers to the deviation amount in the welding execution record of a record with the defect judgment data indicating “defective” among the extracted records, and derives the minimum value of the deviation amount (the result of analysis of the defect occurrence tendency). Then, in Step S704, the welding assist module 202G generates assist information based on the result of analysis of the defect occurrence tendency derived by the defect analysis module 202C.

Next, in Step S710 (Step S130 or Step S150), the output processing module 205 transmits the welding condition and the assist information by the welding assist module 202G to the welder's terminal 5A of the welder 50A. In Step S711 (Step S131 or Step S151), when receiving the welding condition and the assist information from the welding data processing device 2, the welder's terminal 5A displays the preheating support screen or the welding support screen based on the welding condition and the assist information. The welder 50A can grasp in advance how much deviation causes a weld defect by checking the assist information (for example, the minimum value of the deviation amount) displayed on the preheating support screen or the welding support screen. The welding assist module 202G may generate assist information including a defect occurrence ratio exhibited when the welder 50A who is to perform the welding process has performed the welding process in the past under the same welding condition as that for the weld point 11 as the assist target. The welder 50A grasps the defect occurrence ratio thereof in advance and, when the defect occurrence ratio is high, is promoted to perform the welding process with caution, and hence the weld quality can be improved.

As described above, the welding assist module 202G generates assist information including a feature of the welding execution record for which a weld defect is predicted to occur at a weld point 11 as an assist target based on information registered in the welding process database 211 and the inspection process database 212. The welder 50A can perform the welding process while referring to the assist information provided before the welding process is performed, and hence the weld quality and the productivity can be improved.

(9) Defect Prediction Advice Function after Welding Process, Using Defect Occurrence Tendency

The defect prediction module 202H performs defect prediction processing of predicting whether there is a weld defect at a weld point 11 as a prediction target and generating advice information including the prediction result, based on the welding condition and the welding execution record at the weld point 11 and the defect occurrence tendency obtained by analysis of information registered in the welding process database 211 and the inspection process database 212 performed by the defect analysis module 202C. The weld point 11 as the prediction target may be any weld point 11 corresponding to a record in which a welding condition and a welding execution record are registered in the weld point table 211A of the welding process database 211. Therefore, the defect prediction processing is performed at any timing after a welding process is performed at the weld point 11 as the prediction target.

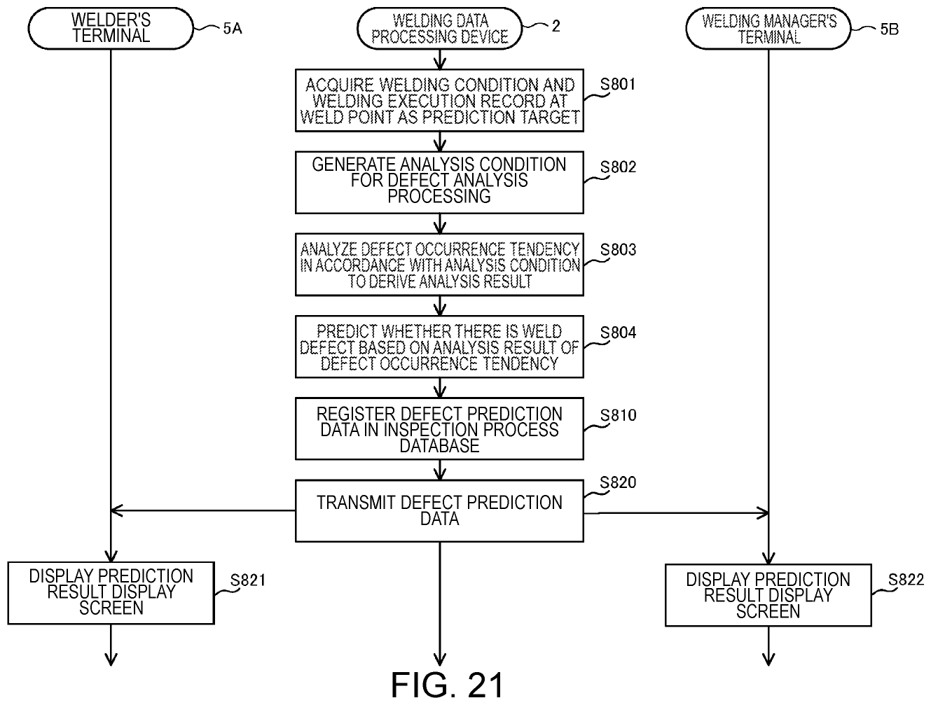

FIG. 21 is a flowchart of an example of the defect prediction processing. FIG. 21 shows an operation in the case in which the defect prediction module 202H performs the defect prediction processing after Step S162 or Step S164 of FIG. 10.

First, in Step S801, the defect prediction module 202H receives the weld point 11 identified by the welding process target record as the weld point 11 as the prediction target, to thereby acquire the welding condition and the welding execution record registered in the welding process target record of the weld point table 211A.

Next, in Step S802, the defect prediction module 202H generates an analysis condition for the defect analysis processing to be performed by the defect analysis module 202C, based on the welding condition and the welding execution record at the weld point 11 as the prediction target. As for the analysis condition here, for example, a weld defect occurrence ratio by grand total is specified as a statistical method and a statistical index value, and the same or predetermined similar range as/to the welding condition and the welding execution record at the weld point 11 as the prediction target are specified as an analysis target range. Specifying an analysis axis is omitted.

Next, in Step S803, the defect analysis module 202C analyzes the defect occurrence tendency under the analysis condition generated by the defect prediction module 202H to derive the analysis result. In the example of the above-mentioned analysis condition, the defect analysis module 202C extracts a record with a welding condition and a welding execution record that are the same as or within a predetermined similar range to the welding condition and the welding execution record at the weld point 11 as the prediction target, from the weld point table 211A of the welding process database 211 and the weld point table 212A of the inspection process database 212. The defect analysis module 202C then derives a ratio in which the total number of the extracted records is a denominator and the total number of records with the defect judgment data indicating “defective” among the extracted records is a numerator, that is, a weld defect occurrence ratio (the result of analysis of the defect occurrence tendency).

Next, in Step S804, the defect prediction module 202H predicts whether there is a weld defect based on the result of analysis of the defect occurrence tendency derived by the defect analysis module 202C. In the example of the above-mentioned analysis condition, the defect prediction module 202H gives the prediction result indicating “defective” when the weld defect occurrence ratio is a predetermined reference value or more, and gives the prediction result indicating “non-defective” when the weld defect occurrence ratio is less than the predetermined reference value. The defect prediction module 202H may use the weld defect occurrence ratio as the result of prediction of whether there is a weld defect.

Next, in Step S810, the defect prediction module 202H refers to the welding process database 211 and identifies a record corresponding to the weld point 11 as the prediction target in the weld point table 212A. The defect prediction module 202H then registers defect prediction data indicating the result of prediction of whether there is a weld defect in the identified record.

Next, in Step S820, the output processing module 205 transmits the defect prediction data obtained by the defect prediction module 202H to the welder's terminal 5A of the welder 50A and the welding manager's terminal 5B of the welding manager 50B who manages the welder 50A.

Then, in Step S821 and Step S822, when receiving the defect prediction data from the welding data processing device 2, the welder's terminal 5A and the welding manager's terminal 5B display a prediction result display screen based on the defect prediction data.

As described above, the defect prediction module 202H predicts whether there is a weld defect at the weld point 11 as the prediction target based on information registered in the welding process database 211 and the inspection process database 212. The welder 50A and the welding manager 50B (who may be the site manager 40 or any of the workers 50C to 50E) determine, for example, necessity of repair welding or re-welding, priority of a radiographic test, or the like in response to display of the prediction result display screen based on the prediction result, and hence it is possible to speed up decision-making and improve the weld quality.

(10) Defect Inference Advice Function after Welding Process, Using Learning Model

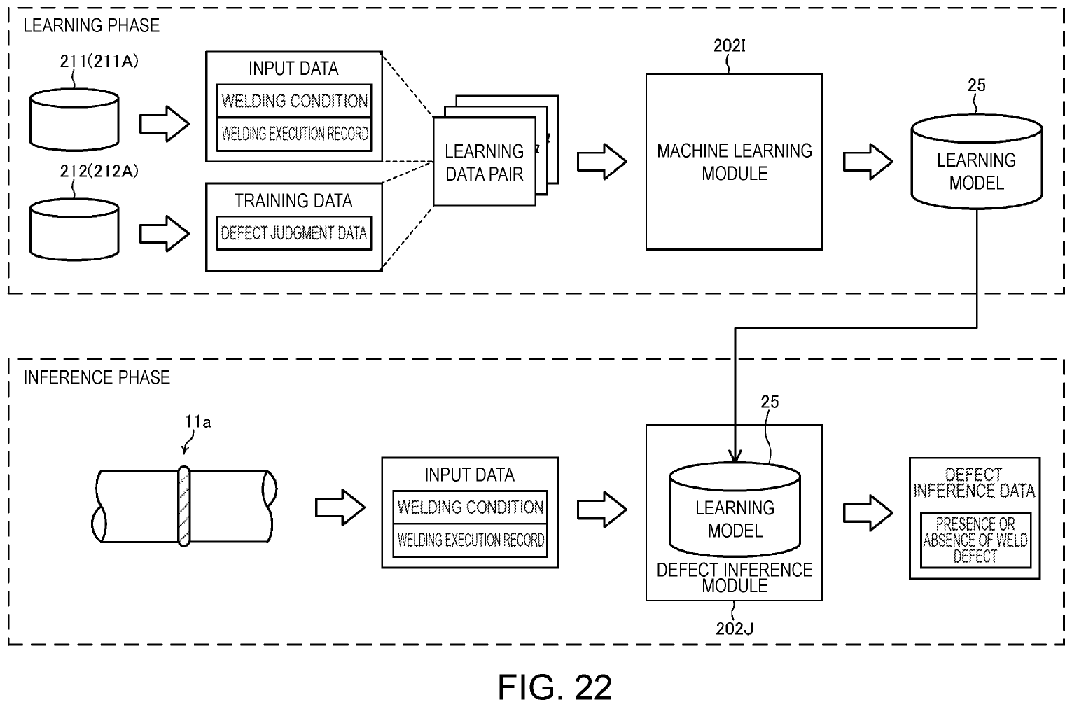

FIG. 22 is a schematic diagram of an example of machine learning processing and defect inference processing.

The machine learning module 2021 performs machine learning processing that inputs a plurality of learning data pairs to a learning model 25 to cause the learning model 25 to learn a correlation between input data and training data by machine learning. Each learning data pair is configured by associating, for a common weld point 11, a welding condition and a welding execution record registered in the weld point table 211A as the input data and defect judgment data registered in the weld point table 212A as the training data with each other in the welding process database 211 and the inspection process database 212.

The learning model 25 is configured by, for example, a neural network (including deep learning). A welding condition and a welding execution record (that may be a part of data) are input to an input layer of the learning model 25, and an output layer of the learning model 25 outputs defect inference data for the welding condition and the welding execution record thus input. The learning model 25 may output the inference result (binary classification) of judgment of whether there is a weld defect as the defect inference data or output the inference result (multi-value classification) of judgment of the type of weld defect together with the presence or absence of a weld defect as the defect inference data. In the case of handling the welding machine operation data 12 and the preheating data 13 as time-series data, the learning model 25 is preferably configured by a recurrent neural network. In addition, the method of machine learning is not limited to machine learning using a neural network, and another machine learning method may be employed. The other machine learning method is, for example, a tree type such as decision tree, ensemble learning, clustering, multivariate analysis, and support vector machine.

The machine learning module 2021 inputs input data configuring a learning data pair to the input layer of the learning model 25, and then adjusts weighting factors associated between the input and output layers such that an evaluation value of an error function that compares defect inference data output from the output layer of the learning model 25 and training data configuring the learning data pair with each other become smaller, by using the error function. The machine learning module 2021 repeats the above-mentioned operation through use of a plurality of learning data pairs, and stores weight parameters at the time when a predetermined learning end condition is satisfied as the trained learning model 25 in the memory unit 21, for example.

The defect inference module 202J performs defect inference processing of inferring whether there is a weld defect at a weld point 11a as an inference target and generating advice information including the inference result by inputting a welding condition and a welding execution record at the weld point 11a to the learning model 25 (with its weight parameters adjusted) as the input data. The weld point 11a as the inference target may be any weld point 11 corresponding to a record with a welding condition and a welding execution record registered in the weld point table 211A of the welding process database 211. Therefore, the defect inference processing is performed at any timing after a welding process is performed at the weld point 11a as the target of inference.

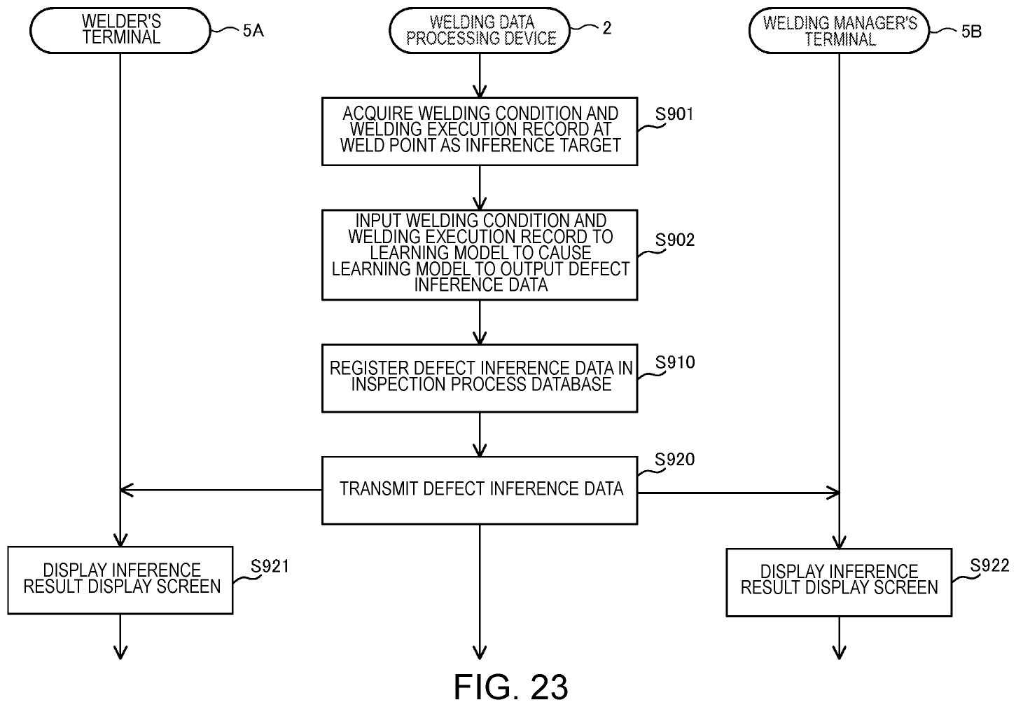

FIG. 23 is a flowchart of an example of the defect inference processing. FIG. 23 shows an operation in the case in which the defect inference module 202J performs the defect inference processing after Step S162 or Step S164 of FIG. 10.

First, in Step S901, the defect inference module 202J receives the weld point 11 identified by the welding process target record as the weld point 11a as the inference target, to thereby acquire the welding condition and the welding execution record registered in the welding process target record of the weld point table 211A.

Next, in Step S902, the defect inference module 202J inputs the welding condition and the welding execution record at the weld point 11a as the inference target to the input layer of the learning model 25, and causes the output layer of the learning model 25 to output defect inference data.

Next, in Step S910, the defect inference module 202J refers to the welding process database 211 and identifies a record corresponding to the weld point 11 identified by the welding process target record in the weld point table 212A. The defect inference module 202J then registers the defect inference data output from the learning model 25 in the identified record.

Next, in Step S920, the output processing module 205 transmits the defect inference data output from the learning model 25 to the welder's terminal 5A of the welder 50A and the welding manager's terminal 5B of the welding manager 50B who manages the welder 50A.

Then, in Step S921 and Step S922, when receiving the defect inference data from the welding data processing device 2, the welder's terminal 5A and the welding manager 50B display an inference result display screen based on the defect inference data.

As described above, the defect inference module 202J infers whether there is a weld defect at the weld point 11a as the inference target based on information registered in the welding process database 211 and the inspection process database 212. The welder 50A and the welding manager 50B (who may be the site manager 40 or any of the workers 50C to 50E) determine, for example, necessity of repair welding or re-welding, priority of a radiographic test, or the like in response to display of the inference result display screen based on the inference result, and hence it is possible to speed up decision-making and improve the weld quality.

### OTHER EMBODIMENTS

The present invention is not limited to the above-mentioned embodiment, and various modifications can be made without departing from the gist of the present invention. Further, all of the embodiments thus obtained are included in the technical idea of the present invention.

For example, the information processing module 202 has been described as including the modules 202A to 202J in the above-mentioned embodiment, as illustrated in FIG. 5. However, the information processing module 202 may include only a part of the modules 202A to 202J. In addition, in the flowcharts for illustrating the processing executed by the modules 202A to 202J of the information processing module 202, the execution order of steps may be appropriately changed, or a part of the steps may be omitted.

Moreover, the image data 14 has been described as being generated by the inspection machine 7 in the above-mentioned embodiment. Alternatively, the image data 14 may be generated by scanning a film on which radiation transmitted through a weld point is imaged with an image reading device such as a scanner.

Further, the input data of the learning model 25 in the machine learning module 2021 and the defect inference module 202J has been described as the welding condition and the welding execution record at the weld point 11 in the above-mentioned embodiment. However, the input data of the learning model may be the image data 14 at the weld point 11. In this case, the information processing module 202 may further include a machine learning module and a defect inference module separately from the machine learning module 2021 and the defect inference module 202J in such a manner that the machining learning module causes a learning model to learn a correlation between input data and training data by machine learning based on a learning data pair configured by the image data 14 as the input data and the defect judgment data as the training data, and the defect inference module outputs defect inference data at the welt point 11a as the inference target by inputting the image data 14 at the welding point 11a as the input data to the learning model that has been trained.

### REFERENCE SIGNS LIST

1 . . . welding integrated management system, 2 . . . welding data processing device, 3 . . . construction progress management device, 4 . . . manager's terminal, 5A . . . welder's terminal, 5B . . . welding manager's terminal, 5C . . . imaging worker's terminal, 5D . . . judge's terminal, 5E . . . inspection manager's terminal, 6 . . . welding machine, 7 . . . inspection machine, 8 . . . network, 10 . . . welding site, 11, 11a . . . weld point, 12 . . . welding machine operation data, 13 . . . preheating data, 14 . . . image data, 20 . . . control unit, 21 . . . memory unit, 22 . . . communication unit, 23 . . . input unit, 24 . . . display unit, 25 . . . learning model, 30 . . . beacon receiving device, 31 . . . beacon card, 40 . . . site manager, 41 . . . card reader, 42 . . . analysis condition input screen, 43 to 45 . . . analysis result display screen, 50A . . . welder, 50B . . . welding manager, 50C . . . imaging worker, 50D . . . judge, 50E . . . inspection manager, 51 . . . card reader, 60 . . . welding machine monitoring device, 61 . . . temperature measurement device, 62 . . . distribution board, 63 . . . welding torch, 64 . . . power supply circuit, 65 . . . operation control panel, 66 . . . gas tank, 70 . . . radiation irradiation unit, 71 . . . detector, 72 . . . guide, 73 . . . driving unit, 74 . . . operation control panel, 200 . . . welding process registration module, 201 . . . inspection process registration module, 202 . . . information processing module, 202A . . . qualification judgment module, 202B . . . deviation judgment module, 202C . . . defect analysis module, 202D . . . qualification ineligibility analysis module, 202E . . . deviation analysis module, 202F . . . deviation judgment criterion setting module, 202G . . . welding assist module, 202H . . . defect prediction module, 2021 . . . machine learning module, 202J . . . defect inference module, 203 . . . welding process support module, 204 . . . inspection process support module, 205 . . . output processing module, 210 . . . welding data processing program, 211 . . . welding process database, 211A . . . weld point table, 211B . . . welding machine table, 211C . . . welder table, 211D . . . welding manager table, 212 . . . inspection process database, 212A . . . weld point table, 212B . . . inspection machine table, 212C . . . imaging worker table, 212D . . . judge table, 212E . . . inspection manager table, 420 to 423 . . . input field, 430 to 450 . . . display region, 620 . . . switch, 630 . . . electrode, 631 . . . nozzle, 632 . . . switch, 900 . . . computer

1. A welding data processing device, comprising:
a welding process registration module configured to register, for each weld point, a welding condition and a welding execution record in a welding process performed under the welding condition in a welding process database;
an inspection process registration module configured to register, for the each weld point, defect judgment data in an inspection process database, the defect judgment data indicating a result of judgment of whether a weld defect exists at the each weld point based on image data of the each weld point acquired in a radiographic test process; and
an information processing module configured to perform predetermined processing based on information registered in the welding process database and the inspection process database.

2. The welding data processing device according to claim 1, wherein the welding process registration module is configured to register welding machine operation data in which an operating state of a welding machine used in the welding process is recorded, in the welding process database as the welding execution record.

3. The welding data processing device according to claim 1, wherein the welding process registration module is configured to register preheating data in which a preheating state of the each weld point is recorded, in the welding process database as the welding execution record.

4. The welding data processing device according to claim 1, wherein the information processing module includes a defect analysis module configured to analyze a defect occurrence tendency showing a tendency at a time when the weld defect has occurred based on at least one of the welding condition or the welding execution record and the defect judgment data.

5. The welding data processing device according to claim 4,
wherein the welding process registration module is configured to register, in the welding process database, at least one of welder identification information for identifying a welder who has performed the welding process, welding manager identification information for identifying a welding manager who manages the welder, or department identification information for identifying a department to which the welder belongs, and
wherein the defect analysis module is configured to analyze the defect occurrence tendency through use of at least one of the welder, the welding manager, or the department as an analysis axis.

6. The welding data processing device according to claim 4,
wherein the welding process registration module is configured to register, in the welding process database, at least one of welding site identification information for identifying a welding site to which the each weld point belongs or, when the welding site is divided into a plurality of welding areas and is managed by welding area, welding area identification information for identifying a welding area to which the each weld point belongs, and
wherein the defect analysis module is configured to analyze the defect occurrence tendency through use of at least one of the welding site or the welding area as an analysis axis.

7. The welding data processing device according to claim 4,
wherein the welding process registration module is configured to register, in the welding process database, an amount of deviation of the welding execution record with respect to the welding condition when the welding process is performed under the welding condition, and
wherein the defect analysis module is configured to analyze the defect occurrence tendency through use of the amount of deviation as an analysis axis.

8. The welding data processing device according to claim 4,
wherein the welding process registration module is configured to register execution start date and time and execution end date and time when the welding process has been performed under the welding condition, in the welding process database as the welding execution record, and
wherein the defect analysis module is configured to analyze the defect occurrence tendency through use of a work time based on the execution start date and time and the execution end date and time as an analysis axis.

9. The welding data processing device according to claim 4, wherein the information processing module includes a welding assist module configured to generate assist information including a feature of the welding execution record for which the weld defect is predicted to occur at the each weld point as an assist target, based on the welding condition at the each weld point and the defect occurrence tendency.

10. The welding data processing device according to claim 4, wherein the information processing module includes a defect prediction module configured to predict whether the weld defect is present at the each weld point as a prediction target, based on the welding condition and the welding execution record at the each weld point and the defect occurrence tendency.

11. The welding data processing device according to claim 1,
wherein the information processing module is configured to form learning data including the welding condition and the welding execution record as input data and the defect judgment data for the welding condition and the welding execution record as training data, and
wherein the information processing module includes a machine learning module configured to input a plurality of pairs of the learning data to a learning model to cause the learning model to learn a correlation between the input data and the training data by machine learning.

12. The welding data processing device according to claim 11, wherein the information processing module includes a defect inference module configured to input the welding condition and the welding execution record at the each weld point as an inference target to the learning model as the input data to infer whether the weld defect is present at the each weld point.

13. The welding data processing device according to claim 1, wherein the welding process registration module is configured to register welder qualification judgment data in the welding process database as the welding execution record, the welder qualification judgment data indicating a result of qualification eligibility judgment of whether a welder who is to perform the welding process at the each weld point holds a qualification for performing the welding process under the welding condition at the each weld point.

14. The welding data processing device according to claim 13,
wherein the welding process registration module is configured to register, in the welding process database, at least one of welder identification information for identifying a welder who has performed the welding process, welding manager identification information for identifying a welding manager who manages the welder, or department identification information for identifying a department to which the welder belongs, and
wherein the information processing module includes a qualification ineligibility analysis module configured to analyze a tendency of qualification ineligibility occurrence indicating a tendency at a time when ineligibility of the qualification has occurred based on the welding execution record with respect to at least one of the welder, the welding manager, or the department as an analysis axis.

15. The welding data processing device according to claim 1, wherein the welding process registration module is configured to register deviation judgment data indicating a result of deviation judgment of whether the welding execution record deviates beyond a predetermined deviation judgment criterion with respect to the welding condition, in the welding process database as the welding execution record.

16. The welding data processing device according to claim 15,
wherein the welding process registration module is configured to register, in the welding process database, at least one of welder identification information for identifying a welder who has performed the welding process, welding manager identification information for identifying a welding manager who manages the welder, or department identification information for identifying a department to which the welder belongs, and
wherein the information processing module includes a deviation analysis module configured to analyze a tendency of deviation occurrence indicating a tendency at a time when the deviation has occurred based on the welding execution record with respect to at least one of the welder, the welding manager, or the department as an analysis axis.

17. The welding data processing device according to claim 15, wherein the information processing module includes a deviation judgment criterion setting module configured to set the predetermined deviation judgment criterion based on the welding condition, the welding execution record, and the defect judgment data.

18. A welding data processing method, comprising:
a welding process registration step of registering, for each weld point, a welding condition and a welding execution record in a welding process performed under the welding condition in a welding process database;
an inspection process registration step of registering, for the each weld point, defect judgment data in an inspection process database, the defect judgment data indicating a result of judgment of whether a weld defect exists at the each weld point based on image data of the each weld point acquired in a radiographic test process; and
an information processing step of performing predetermined processing based on information registered in the welding process database and the inspection process database.

19. The welding data processing device according to claim 2, wherein the welding process registration module is configured to register preheating data in which a preheating state of the each weld point is recorded, in the welding process database as the welding execution record.

20. The welding data processing device according to claim 2, wherein the information processing module includes a defect analysis module configured to analyze a defect occurrence tendency showing a tendency at a time when the weld defect has occurred based on at least one of the welding condition or the welding execution record and the defect judgment data.
